(19) United States
(12) Patent Application Publication
(10) Pub. No.: US 2016/0297953 A1
(43) Pub. Date: Oct. 13, 2016

(54) Filler-Natural Rubber Composites

(71) Applicant: OHIO STATE INNOVATION FOUNDATION, Columbus, OH (US)

(72) Inventors: Katrina Cornish, Wooster, OH (US); Jessica Slutzky, Wooster, OH (US); Cindy Barrera, Wooster, OH (US); Griffin Michael Bates, Wooster, OH (US)

(73) Assignee: Ohio State Innovation Foundation, Columbus, OH (US)

(21) Appl. No.: 15/028,273

(22) PCT Filed: Oct. 13, 2014
(86) PCT No.: PCT/US14/60262

§ 371 Date: Apr. 8, 2016

Related U.S. Application Data
(60) Provisional application No. 61/889,645, filed on Oct. 11, 2013.

(51) Int. Cl. C08K 11/00; C08K 5/46; C08K 3/22; C08K 3/04

(52) U.S. Cl. CPC C08K 11/005; C08K 3/04; C08K 5/46; C08K 3/22; C08K 2003/2296

(57) ABSTRACT

Rubber composites containing macro-, micro-, and nano-sized fillers made from agricultural, industrial, and food processing wastes, methods of making the same, and articles fabricated therefrom, are described. In a particular embodiment described herein is a rubber composite comprising a) a rubber component selected from the group consisting of: a natural rubber component; and a synthetic rubber component; b) a crosslinking system; one or more accelerators; one or more activators; and a filler comprising vegetable waste, mineral waste, lignocellulosic waste, or a combination thereof.

### CROSS-REFERENCE TO RELATED APPLICATIONS

This application claims priority to U.S. Provisional Application No. 61/889,645, filed on Oct. 11, 2013, the entire disclosure of which is expressly incorporated herein by reference for all purposes.

### STATEMENT REGARDING FEDERALLY SPONSORED RESEARCH

This invention was not made with government support.

### BACKGROUND OF THE INVENTION

Rubber is used as a raw material for the manufacture of over 40,000 products. All natural rubber (NR) and natural rubber latex (NRL) are primarily composed of cis-1,4-polyisoprene. Other components of NRL include proteins, fatty acids, resins, and lipids. However, there are over 2,500 species of plants that produce NRL, and rubber macromolecular structure varies among the species, as does polymer size, polydispersity, composition, gel content, rubber particle composition, particle size distribution, complexity of the rubber biosynthetic apparatus, and the NR properties of the products made from different rubbers.

For example, the protein component of latex includes the proteins associated with the rubber particle membranes as well as the soluble and non-rubber particle-associated membrane-bound proteins that are entrained in the latex upon tapping. The soluble proteins can be removed from latex by washing using a series of concentration, dilution, and reconcentration steps, by enzymatic deproteination, provided this is followed by latex washing or thorough product leaching during manufacture, or by precipitation of soluble proteins.

The lipid content of rubber particles from different species also varies significantly. In species which do not make tappable latex, such as guayule (which has to be homogenized to release the rubber particles from the bark parenchyma cells), the initial latex fraction (essentially the plant homogenate itself) contains large amounts of plant proteins extracted when the plant was homogenized to release the rubber particles. The latex is then purified away from the non-latex components. The compositional differences among different lattices generate different chemistries which exert different effects when the lattices are compounded.

Natural rubber is natural rubber latex that has been dried and baled. Natural rubber possesses unique properties such as self-reinforcement, abrasion, tear, and impact resistance, among others. These properties make natural rubber ideal for applications such as tires, conveyor belts, hoses, and gaskets.

In most any rubber compound, including natural rubber, the polymer is the most expensive component. This has led to the use of the maximum possible loading of cheap mineral- or petroleum-based fillers in polymeric products. In general, mineral fillers increase the modulus of the final product and, sometimes, tearing and abrasion resistance. As such, different fillers may be used when compounding either a natural or synthetic rubber so as to give the resulting rubber composite unique, desired characteristics.

Fillers serve either as inexpensive diluents of the more expensive polymer phase or as reinforcing fillers to improve the physical properties of the rubber product. Diluent fillers must be especially low in cost to be of practical use. Historically, diluent fillers have been made from minerals of various kinds. Reinforcing fillers are expensive, can have high carbon footprints, and generally require a very small particle size (<300 nm).

Natural rubber's inherent properties may be improved by the addition of reinforcing fillers such as carbon black and silica, neither of which is derived from a renewable source, save for a small amount of carbon black. Carbon black is the oldest and most widely used and studied filler for rubber compounds. It is unique in its ability to enhance the properties of nearly any base elastomer system, while at least moderately lowering overall rubber cost. This versatile reinforcing filler may be produced by the incomplete combustion of heavy petroleum products such as fluid catalytic cracking (FCC) tar, coal tar, and ethylene cracking tar. Due to concerns over global petroleum shortages, the cost of carbon black is increasing.

Due to the lack of sustainability and resulting rising cost of fillers derived from non-renewable resources, there is a need for low-cost, renewable fillers for use in rubber compounds that equal or surpass the performance of current carbon-based fillers.

### SUMMARY OF THE INVENTION

Described herein are rubber composites containing macro-, micro-, and nano-sized fillers made from agricultural, industrial, and food processing wastes, methods of making the same, and articles fabricated therefrom.

In a particular embodiment described herein is a rubber composite comprising a) a rubber component selected from the group consisting of: a natural rubber component; and a synthetic rubber component; b) a crosslinking system; one or more accelerators; one or more activators; and a filler comprising vegetable waste, mineral waste, lignocellulosic waste, or a combination thereof. In other embodiments, the filler comprises carbon fly ash, eggshell, guayule bagasse, tomato peel, or a combination thereof. In certain embodiments the filler comprises tomato peel, eggshell, or a combination thereof. In yet another embodiment, the rubber component is guayule, and the filler comprises carbon fly ash, eggshell, guayule bagasse, tomato peel, or a combination thereof.

In other embodiments described herein, the rubber composite comprises micro-sized particles having an average particle size of from about 1 μm to about 38 μm. In yet other embodiments described herein, the rubber composite comprises macro-sized particles having an average particle size of from about 38 μm to about 300 μm. In still other embodiments, the rubber composite comprises nano-sized particles having an average particle size of less than about 1 μm.

In certain embodiments described herein, the rubber component of the rubber composite is a natural rubber selected from the group consisting of Hevea natural rubber; guayule natural rubber; and Taraxacum kok-saghyz (TKS) natural rubber. In some embodiments, the rubber component of the rubber composite is Hevea natural rubber. In other embodiments, the rubber component of the rubber composite is guayule natural rubber.

In certain embodiments described herein, the accelerators of the rubber composite comprises ZDEC, DPG, Sulfads®, or a combination thereof.

In other embodiments described herein, the vegetable waste used as a filler in the rubber composite is selected from the group consisting of: tomato peel; tomato paste; potato peel; onion peel; lemon peel; tangerine peel; apple peel, banana peel; and kiwi peel.

In yet other embodiments, the mineral waste used as a filler in the rubber composite is selected from the group consisting of: carbon fly ash; eggshell; bauxite residues; drilling debris; aluminum dross; cement waste; coal mine schist; geological mine tailings; sewage sludge ash; sludge solids; steel slag; zeolites; zinc slag; polyhydroxy butrate valerate (PHBV); starch-based plastics; polylactic acid (PLA); poly-3-hydroxybutyrate (PHB); poly-3-hydroxyalkanoate (PHA); polyamide 11 plastics; and floss. In particular embodiments, the mineral waste used as a filler in the rubber composite is carbon fly ash, eggshell, or a combination thereof.

In still other embodiments described herein, the lignocellulosic waste used as a filler in the rubber composite is selected from the group consisting of: guayule bagasse; Tarazacum kok-saghyz floss; paper sludge; cardboard; straw; sawdust; and pine bark.

In certain embodiments described herein, the rubber composite further comprises one or more of stearic acid, zinc oxide, and antioxidants.

In particular embodiments described herein, the filler is present in the rubber composite at about 35 PHR. In other embodiments described herein, the rubber composite further comprises carbon black, wherein the total amount of filler and carbon black is about 35 PHR. In certain embodiments described herein, the filler is present in the rubber composite at about 0.1 PHR to about 34.9 PHR and while the carbon black is present in the rubber composite at about 34.9 PHR to about 0.1 PHR, and the two are in present in such amounts as to add up to about 35 PHR.

In certain embodiments described herein, the crosslinking system in the rubber composite is selected from the group consisting of: a sulfur crosslinking system; a peroxide crosslinking system; a urethane crosslinking system; a metallic oxide crosslinking system; an acetoxysilane crosslinking system; and a radiation-based crosslinking system. In particular embodiments, the crosslinking system is a sulfur crosslinking system.

In a particular embodiment described herein is a method of making a rubber composite comprising compounding a natural rubber component, a synthetic rubber component, or a mixture thereof, with at least one filler selected from the group consisting of: carbon fly ash; guayule bagasse; eggshell; and tomato peel. In certain embodiments, a natural rubber component is used in the method of making a rubber composite. Particularly, in certain embodiments, the natural rubber component is selected from the group consisting of: Hevea natural rubber; guayule natural rubber; and Taraxacum kok-saghyz (TKS) natural rubber. More particularly, in certain embodiments, the natural rubber is Hevea natural rubber or guayule natural rubber.

In certain embodiments described herein, the method of making a rubber composite further comprises adding one or more additives selected from the group consisting of: a crosslinking system; accelerators; activators; plasticizers; softeners; carbon black; silica; and processing agents. In particular embodiments, at least one of the additives is carbon black. Wherein at least one of the additives is carbon black, the filler and carbon black are compounded at a total concentration of about 35 PHR.

In other embodiments described herein, the method of making the rubber composite comprises using micro-sized filler particles having an average particle size of from about 1 μm to about 38 μm. In yet other embodiments described herein, the method of making the rubber composite comprises using macro-sized filler particles having an average particle size of from about 38 μm to about 300 μm. In still other embodiments, the method of making the rubber composite comprises using nano-sized filler particles having an average particle size of less than about 1 μm.

In another embodiment described herein, is a product of the method of making a rubber composite described herein.

In a particular embodiment described herein is a method of making a rubber product comprising a) providing a rubber composite described herein; and b) molding the rubber composite into a rubber product, wherein molding comprises a method selected from the group consisting of: compression molding; transfer molding; and injection molding. In one embodiment, the rubber product is a gasket.

In another particular embodiment described herein, is a filler for use in a solid rubber compound comprising tomato peel, eggshell, or a combination thereof. In certain embodiments, the filler size is selected from macro-sized particles (average particle size of from about 38 μm to about 300 μm), micro-sized particles (average particle size of from about 1 μm to about 38 μm), and nano-sized particles (average particle size of less than about 1 μm). In certain embodiments described herein is a synthetic rubber compound comprising a filler described herein. In other embodiments described herein are natural rubber compounds comprising fillers described herein.

### BRIEF DESCRIPTION OF THE DRAWINGS

FIG. 1: Flow chart illustrating how macro- and micro-sized waste filler particles were generated from waste sources.

FIG. 2: Diagram showing waste filler and carbon black loading in filler-rubber composites used in assessing the effects of particle size and waste filler:carbon black filler ratio on physical performance of the resulting rubber composites.

FIGS. 3A-3D: Photographs of bulk filler particles (left panels) and scanning electron microscope images (right panels) of: FIG. 3A) carbon fly ash filler; FIG. 3B) guayule bark bagasse filler; FIG. 3C) eggshell filler; FIG. 3D) tomato peel filler.

FIGS. 4A-4C: Line graphs showing the effect of various waste filler:carbon black ratios in guayule natural rubber on: FIG. 4A) tensile strength (MPa); stress at 500% elongation (modulus); and ultimate elongation (%). Waste fillers include (from left to right) carbon fly ash, eggshells, guayule bagasse, and tomato peel.

FIGS. 5A-5C: Line graphs showing the effect of various waste filler:carbon black ratios in Hevea natural rubber on: FIG. 4A) tensile strength (MPa); stress at 500% elongation (modulus); and ultimate elongation (%). Waste fillers include (from left to right) carbon fly ash, eggshells, guayule bagasse, and tomato peel.

FIGS. 6A-6F: SEM micrographs of filler particles: FIG. 6A) micro-sized tomato peel; FIG. 6B) carbon black; FIG. 6C) macro-sized tomato peel; FIG. 6D) carbon fly ash; FIG. 6E) eggshell; and FIG. 6F) guayule bagasse.

FIG. 7: Stress vs. Strain curves of Hevea rubber composites made with different amounts of carbon fly ash, using macro-sized particles (left panel) or micro-sized particles (right panel).

FIG. 8: Stress vs. Strain curves of Hevea rubber composites made with different amounts of guayule bagasse, using macro-sized particles (left panel) or micro-sized particles (right panel)

FIG. 9: Stress vs. Strain curves of Hevea rubber composites made with different amounts of eggshell, using macro-sized particles (left panel) or micro-sized particles (right panel).

FIG. 10: Stress vs. Strain curves of Hevea rubber composites made with different amounts of tomato peel, using macro-sized particles (left panel) or micro-sized particles (right panel).

FIGS. 11A-11E: SEM micrographs of Hevea natural rubber composites with: FIG. 11A) carbon black; FIG. 11B) micro-sized tomato peel at 10 PHR; FIG. 11C) micro-sized carbon fly ash at 20 PHR; FIG. 11D) micro-sized eggshell at 20 PHR; and FIG. 11E) micro-sized guayule bagasse at 20 PHR.

FIG. 12: Dendrogram obtained by hierarchical clustering analysis of 30 composite formulations.

FIGS. 13A-13B: Comparison of the effects on hardness number of various loadings of waste fillers in rubber composites between FIG. 13A) guayule rubber and FIG. 13B) Hevea rubber.

### DETAILED DESCRIPTION

Throughout this disclosure, various publications, patents and published patent specifications are referenced. The disclosures of these publications, patents and published patent specifications are hereby incorporated by reference into the present disclosure to more fully describe the state of the art to which this invention pertains.

Various embodiments are described in the present disclosure in the context of filler-rubber composites, including natural rubber filler-rubber composites and synthetic rubber filler-rubber composites, rubber fillers, methods of making a filler-natural rubber composite, and products made from filler-rubber composites described herein. Those of ordinary skill in the art will realize that the following detailed description of the embodiments is illustrative only and not intended to be in any way limiting. Other embodiments will readily suggest themselves to such skilled persons having the benefit of this disclosure. Reference to an “embodiment,” “aspect,” or “example” in this disclosure indicates that the embodiments of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Not all of the routine features of the implementations or processes described herein are shown and described. It will, of course, be appreciated that in the development of any such actual implementation, numerous implementation-specific decisions will be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking for those of ordinary skill in the art having the benefit of this disclosure.

Definitions

For convenience, certain terms employed in the specification, examples, and appended claims are collected here, before further description of the invention. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” are used to refer to one or to more than one (i.e., to at least one) of the grammatical object of the article. By way of example, “an element” means one element or more than one element.

The term “plurality” means more than one.

The terms “comprise” and “comprising” are used in the inclusive, open sense, meaning that additional elements may be included.

The term “including” is used to mean “including but not limited to”. “Including” and “including but not limited to” are used interchangeably.

The term “filler” refers to a particle added to a rubber compound or composite in order to lower the consumption or use of more expensive polymers. A filler may be either a diluent filler or a reinforcing filler. A filler may be derived from a waste source, such as food and agricultural processing waste.

The term “hardness number” refers to the ratio of an applied load to the surface area of the indentation caused by the load.

The terms “vulcanization” and “cure” or “curing” refer to a chemical process for modifying a polymer by forming crosslinks between individual polymer chains.

The terms “vulcanizate” or “vulcanisate” as used interchangeably herein refer to the product of a vulcanization process. A vulcanizate is a cross-linked polymer.

The term “crosslinking system” refers to one or more chemical agents, physical conditions, or a combination thereof used to cure, or vulcanize, a polymer. A crosslinking system may be based on a particular chemical, chemical compound, or physical condition. For example, a sulfur crosslinking system involves the curing of a polymer by the addition of sulfur to a polymer compound. By way of another example, a radiation-based crosslinking system may comprise the addition of radiation-activated additives to the polymer compound, followed by irradiation of the polymer compound, resulting in the activation of the additives, and the crosslinking of the polymer.

The term “tensile strength” refers to the maximum amount of tensile stress a material can withstand before breaking.

The term “floss” refers to any silky or fibrous material obtained from plants, such as fibers obtained from cotton and Taraxacum kok-saghyz dandelion.

The acronym “PHR” stands for Parts per Hundred Rubber, which is a measure of concentration known in the rubber compounding art. As used herein, “PHR” means the weight of a component per 100 grams of elastomer.

The term “modulus” refers to elastic modulus, or the tendency of an object to be deformed elastically when a force is applied to it. Modulus is also an indicator of the softness of an object: the lower the modulus, the softer the material.

The term “MPa” refers to a megapascal, or 1,000,000 Pa. A pascal is a measure of force per unit area. One pascal is equal to one newton per square meter (1 N/m²).

General Description

There is increasing interest on developing bio-based materials in order to reduce dependency on fossil fuels, valorize agricultural and industrial residues, and generate more sustainable materials while concomitantly minimizing pollution and reducing overall cost of rubber production. Nevertheless, studies on natural rubber composites in the last decade have mainly focused in cellulosic fillers. Cellulose has been considered as a source of filler for elastomers and plastics due to its renewable characteristics, degradability, abundance and diversity of sources, as well as for the high mechanical properties given that is naturally a structural material. Little evaluation has been done of other waste streams that could confer similar characteristics to composites.

Four abundant processing residues—processing tomato peels, carbon fly ash, guayule defoliated stem bagasse and eggshells—are considered in this study as alternative fillers for natural rubber composites. The diversity of mechanical properties obtained from different rubber composites compounded with these processing residues used as filler is discussed herein.

Tomato peels and eggshells are significant sources of solid waste generated from the food processing sector. Millions of tons of tomatoes are processed annually generating a waste equivalent to 40% of the initial material. In 2013, 95.176 billion eggs were produced in the United States alone. On the other hand, guayule bark bagasse is obtained as by-product of latex extraction from the guayule shrub, an important source of natural rubber that is increasing in demand due to the lack of allergy responses associated to the latex, compared to traditionally use natural rubber latex. Carbon fly ash is an inexpensive and readily available material waste material.

The utilization of low cost materials as fillers could reduce the cost of final rubber products; however, due to the demanding conditions under which natural rubber products are used, the properties of the composite materials must be evaluated. Primary factors to consider when selecting reinforcing fillers are particle size, loading, structure, and surface activity. These factors affect the dispersion of the filler in the rubber matrix, as well as filler-filler and polymer-filler interactions and determine the final physical properties. Natural rubber composite properties achieved with different polymer-filler interfaces, particle sizes and loadings are described herein.

Solid rubber composites may be compounded with fillers, which may serve either as inexpensive diluents of the more expensive polymer phase or reinforcing fillers to improve the physical properties of the rubber composite. Fillers of various types are used as material diluents to lower the cost of both natural and synthetic solid rubber products, but often to the detriment of their physical properties. Thus, to meet an unmet need in the industry, provided herein are solid rubber composites in which different loadings of macro-, micro-, and nano-sized fillers made from sustainable wastes, such as food and agricultural processing wastes, have been incorporated. In certain embodiments, the filler-rubber composites meet or exceed the ASTM D1330-04 standards for rubber sheet gaskets. In certain embodiments, a filler-natural rubber composite comprises Hevea natural rubber, guayule natural rubber, and Taraxacum kok-saghyz (TKS) natural rubber, or combinations thereof. In other embodiments, the filler-rubber composite comprises a synthetic polymer. As described below, the polymer sources respond differently to different fillers. Many of the filler-rubber composites described herein have similar properties, or have superior properties, to rubber composites comprising standard fillers, such as carbon black and silica.

The fillers described herein are macro-, micro-, or nano-fillers made from high volume wastes. The macro-fillers generally have a particle size ranging from about 38 μm to about 300 μm. The micro-fillers generally have a particle size ranging from about 1 μm to about 38 μm, and can be made from wet milling, dry milling, or a combination thereof, and sieving suitable wastes. The nano-fillers generally have a particle size of smaller than 1μ, and can be made from suitable wastes similarly to the micro-fillers. In certain embodiments, the particle size of the fillers is smaller than the interchain distance of the polymer, and can be made from wet milling suitable wastes in water via pebble milling, optionally followed by drying and dry milling. The three sizes of fillers can improve product performance while reducing polymer usage in solid rubber compounding and rubber product manufacturing. Without wishing to be bound by any particular theory, the mechanical properties of solid rubber composites are improved via a reinforcing effect that utilizes phenomena such as molecular surface rearrangements, particle displacements, interparticle chain breakage, and strong and weak binding. As will be made apparent from this disclosure, careful selection of filler type, size distribution, and loading can be used to specifically alter individual aspects of physical performance without changing other aspects. Thus, the customization of rubber composites for specific product applications is possible with the benefit of the present disclosure.

Food processing wastes, industrial wastes, and agricultural wastes are residual materials produced during the conversion of agricultural commodities into marketable products or food items, and include wastes from raw materials, pre- and post-processing wastes, industrial effluents, and sludge. The normal disposal modes of solid wastes are composting and landfill applications, which create additional cost for processing companies. Only 3% of food wastes are recycled in the U.S., largely due to inadequate infrastructure to process the enormous quantity of food wastes, monetary restrictions of recycling facilities, and the presence of potential contaminants in some food wastes. This abundant, unused supply means that a wide range of bio-based and mineral waste materials are available in quantities suitable for large-scale production of different products having wastes as functional fillers. The skilled person will understand that the waste materials described herein can be readily modified by milling or by chemical treatments in order to alter and optimize their interaction with polymer matrices, and that such alterations or optimizations are entirely within the scope of the present disclosure.

Many different types of wastes are possible as fillers in solid rubber composites. By way of non-limiting example, suitable wastes for use as fillers in solid rubber composites include, but are not limited to: vegetable wastes such as tomato paste or tomato peel, as well as peels of potatoes, apples, onions, lemons, tangerines, bananas, kiwis, or the like; mineral wastes such as carbon fly ash, calcium carbonate from eggshells (with or without the membrane removed), bauxite residues, drilling debris, aluminum dross, cement waste, coal mine schist, geological mine tailings, sewage sludge ash, sludge solids, steel slag, zeolites, or zinc slag; bioplastics such as polyhydroxy butrate valerate (PHBV), starch-based plastics, polylactic acid (PLA) plastics, poly-3-hydroxyburtyrate (PHB), poly-3-hydroxyalkanoate (PHA), polyamide 11 (PA 11) plastics, or floss; lignocellulosic wastes such as bagasse from the rubber-producing crops guayule or Taraxacum kok-saghyz (TKS), paper sludge, cardboard, straw, sawdust, or bark from pine in its different varieties such as radiate, cry, eucalyptus, acacia, oak, rauli, and beech; biofuels crop wastes, such as corn stover; or combinations thereof. In specific examples described herein, filler-rubber composites were produced loaded with fillers selected from tomato peels, carbon fly ash, calcium carbonate from eggshells (without membrane), and guayule bark bagasse. Bagasse is a suitable filler because the residual rubber (and resin in guayule) in the bagasse causes an additional interaction with the polymer blend as it becomes part of the active compound.

The production of rubber composites filled with food, agricultural, or industrial wastes is a downstream utilization of such waste, and therefore saves in waste disposal costs. The rubber composites comprising fillers described herein can be produced with lower costs than other rubber composites, and, as described herein and shown in the figures, have comparable or better performance characteristics than rubber composites filled with conventional fillers. It should be understood that rubber composites can be made with a combination of fillers. Generally, the behavior of such rubber composites can be predicted from the behavior of rubber composites with a single filler type. Therefore, the examples and figures herein illustrate rubber composites with single fillers and demonstrate that films having multiple fillers are entirely within the scope of the present disclosure.

Filler-rubber composites may be made using any of several possible polymer sources, or rubber components. By way of non-limiting example, suitable natural rubber components include, but are not limited to: Brazilian rubber tree rubber (Hevea brasiliensis), guayule rubber (Parthenium argentatum), gopher plant rubber (Euphorbia lathyris), mariola rubber (Parthenium incanum), rabbi thrush rubber (Chrysothanmus nauseosus), candelilla rubber (Pedilanthus macrocarpus), Madagascar rubbervine rubber (Cryptostegia grandiflora), milkweeds rubber (Asclepias syriaca, speciosa, subulata, et al.), goldenrods rubber (Solidago altissima, graminifolia, rigida, et al.), Russian dandelion rubber (Taraxacum kok-saghyz (TKS)), mountain mint rubber (Pycnanthemum incanum), American germander rubber (Teucreum canadense), tall bellflower rubber (Campanula americana), and rubber from plants from the Asteraceae (Compositae), Euphorbiaceae, Campanulaceae, Labiatae, and Moraceae families. Latex extracted from any one of these plants is dried and baled for use as a rubber component for a filler-rubber composite described herein. Currently, only natural rubber from Hevea and guayule are commercially produced. However, any of the above natural rubber sources are capable of being used in the methods and formulations discussed herein to produce useful filler-rubber composites.

In particular embodiments, the rubber component is a natural rubber selected from a Hevea natural rubber, a guayule natural rubber, and a TKS natural rubber. In one embodiment, the rubber component is a Hevea natural rubber. In another embodiment, the rubber component is a guayule natural rubber.

Filler-rubber composites may also be made using any of several possible synthetic rubber components. By way of non-limiting example, suitable natural rubber components include, but are not limited to: styrene butadiene (SBR); polybutadiene; ethylene propylene diene monomer (EPDM); hydrogenated nitrile butadiene (HNBR); and isobutylene isoprene butyl. In one embodiment, the rubber component is styrene butadiene. In another embodiment, the rubber component is polybutadiene.

To make a filler-rubber composite, a rubber component is compounded with at least one filler. The compounding may further include the addition of one or more accelerators, one or more activators, one or more antioxidants, one or more mixing aids, one or more molding aids, or a combination thereof. The filler-rubber composite may be cured using any crosslinking system known in the art, including but not limited to: a sulfur crosslinking system; a peroxide crosslinking system; a urethane crosslinking system; a metallic oxide crosslinking system; an acetoxysilane crosslinking system; and a radiation-based crosslinking system. One of skill in the art will readily recognize that different combinations of accelerators, activator, antioxidants, mixing aids, molding aids, and other additives may be included in the compounding of a filler-rubber composite, thereby giving the filler-rubber composite unique, desirable characteristics.

In particular embodiments, the waste fillers described herein may partially or completely replace a common filler such as carbon black or silica in a rubber composite. Therefore, in some embodiments, a filler-rubber composite may comprise both the waste fillers described herein and carbon black. The waste fillers described herein may be present in the filler-rubber composite at dry weight concentrations ranging from about 0.1 PHR to about 35 PHR. In embodiments where the filler-composite comprises both waste fillers and carbon black, carbon black may be present in the filler-rubber composite at dry weight concentrations ranging from about 0 PHR to about 34.9 PHR. In preferred embodiments, the total filler content of a filler-rubber composite is about 35 PHR. Therefore, where a filler-rubber composite comprises both waste fillers and carbon black, the total filler content of the filler-rubber composite is about 35 PHR. For example, if waste fillers are present at about 20 PHR, carbon black will be present at about 15 PHR, giving a total filler content of about 35 PHR. In one embodiment, the filler-rubber composite comprises about 0.1 PHR waste filler and about 34.9 PHR carbon black. In another embodiment, the filler-rubber composite comprises about 5 PHR waste filler and about 30 PHR carbon black. In another embodiment, the filler-rubber composite comprises about 10 PHR waste filler and about 25 PHR carbon black. In another embodiment, the filler-rubber composite comprises about 15 PHR waste filler and about 20 PHR carbon black. In another embodiment, the filler-rubber composite comprises about 20 PHR waste filler and about 15 PHR carbon black. In another embodiment, the filler-rubber composite comprises about 25 PHR waste filler and about 10 PHR carbon black. In another embodiment, the filler-rubber composite comprises about 30 PHR waste filler and about 5 PHR carbon black. In yet another embodiment, the filler-rubber composite comprises about 35 PHR waste filler and no carbon black.

Those of skill in the art will recognize that the total filler content of a filler-rubber composite may be either less or greater than about 35 PHR. The total filler content of a filler-rubber composite may range from as little as about 1 PHR, or less, to a maximum filler content that a given polymer. In certain embodiments, the total filler content of a filler-rubber composite is selected from a group consisting of: about 1 PHR; about 2 PHR; about 3 PHR; about 4 PHR; about 5 PHR; about 10 PHR; about 15 PHR; about 20 PHR; about 25 PHR; about 30 PHR; about 35 PHR; about 40 PHR; about 45 PHR; about 50 PHR; about 55 PHR; about 60 PHR; about 65 PHR; about 70 PHR; about 75 PHR; about 80 PHR; about 85 PHR; about 90 PHR; about 95 PHR; and about 100 PHR. In particular embodiments, the total filler content comprises one or more waste fillers described herein. In yet other embodiments, the total filler content comprises one or more commonly used fillers, such as the reinforcing filler carbon black, and one or more waste fillers described herein. Based on the present disclosure, one of skill in the art would can determine an optimal filler content amount and composition for a filler-rubber composite having particular desired characteristics.

The crosslinking systems described herein are well-known in the art. One of skill in the art may identify an appropriate crosslinking system for use in compounding and curing a filler-rubber composite for a particular purpose. By way of non-limiting example, the crosslinking system used in an embodiment is a sulfur crosslinking system. The source of sulfur can be elemental sulfur or one or more sulfur-containing compounds. Suitable sources of sulfur include, but are not limited to: sulfur powder; precipitated sulfur; colloidal sulfur; insoluble sulfur; high-dispersible sulfur; sulfur halides such as sulfur monochloride and sulfur dichloride; sulfur donors such as 4,4′-dithiodimorpholine; sulfur dispersions; amine disulfides; polymeric polysulfides; aromatic thiazoles; amine salts of mercaptobenzothiazoles; and combinations thereof. In certain embodiments, the sulfur used in a sulfur crosslinking system is a sulfur dispersion. By way of non-limiting example, sulfur dispersions can be prepared by mixing elemental sulfur with a resin and a solvent. In certain embodiments, the dry weight concentration of the crosslinking agent ranges from about 0.5 PHR to about 10 PHR, from about 1 PHR to about 8 PHR, from about 1.5 PHR to about 5PHR, or from about 2 PHR to about 4 PHR. In particular embodiments employing a sulfur crosslinking system, sulfur is present at a concentration of about 3.5 PHR. Those skilled in the art will readily recognize that other crosslinking systems, such as peroxide crosslinking systems, urethane crosslinking systems; metallic oxide crosslinking systems; acetoxysilane crosslinking systems; and a radiation-based crosslinking systems, and with each crosslinking system recognize useful concentrations of active chemicals or chemical compounds.

The one or more accelerators can be selected from a wide variety of suitable accelerators. Suitable accelerators include, but are not limited to, xanthates, dithiocarbamates, thiurams, thiazoles, sulfenamides, guanidines, thiourea derivatives, and amine derivatives. More specifically, suitable accelerators include, but are not limited to: N-terr-butyl-2-benzothiazyl (TBBS); zinc diethyldithiocarbamate (ZDEC), diphenyl guanidine (DPG), Sulfads® (a sulfur donor for NR and synthetic polymers), zinc 2-mercaptobenzothiazole (ZMBT), diisopropyl xanthogen polysulphide (DIXP), zinc diisononyl dithiocarbamate (ZDNC), 2-cyclohexyl-benzothiazyl-sulfenamide (CBS), tetramethylthiuram disulfide, 2-mercaptobenzothiazole (MBT), benzothiazyl-2-sulfenomorepholide (MBS), benzothiazyldicyclohexylsulfenamid (DCBS), diorthotolylguanidine (DOTG), o-tolyl biguanide (OTBG), tetramethylthiuram monosulfide (TMTM), zinc N-dimethyldithiocarbamate (ZDMC), zinc N-dibutyldithiocarbamate (ZDBC), zinc N-ethyl-phenyl-dithiocarbamate (ZEBC), zinc N-pentamethylendithiocarbamate (ZPMC), ethylene thiourea (ETU), diethylene thiourea (DETU), diphenyl thiourea (DPTU), or a combination thereof. In certain embodiments, the accelerator comprises TBBS.

The accelerators can each be present at dry weight concentrations ranging from about 0.01 PHR to about 5 PHR, or from about 0.1 PHR to about 2 PHR, or from about 0.2 PHR to about 1 PHR. In certain embodiments, the accelerator TBBS is present at a concentration of about 0.75 PHR.

The filler-natural rubber may further include one or more of: activators, such as ZnO; ammonium hydroxide; and antioxidants. The antioxidants can be present in the form of an antioxidant dispersion. Activators useful in compounding and curing filler-natural rubber composites included, but are not limited to: ZnO; PbO; Pb₃O₄; and fatty acids, such as stearic acid, oleic acid, and dibutyl ammonium oleate. In certain embodiments, the activator is ZnO. When present, the dry weight concentration of the ZnO ranges from about 0.1 PHR to about 10 PHR, from about 2 PHR to about 8 PHR, or from about 4 PHR to about 6 PHR. In particular embodiments, ZnO is present at a concentration of about 5 PHR. When present, the dry weight concentration of the antioxidants ranges from about 0.01 PHR to about 5 PHR, from about 0.1 PHR to about 4 PHR, or from about 1 PHR to about 3 PHR. In particular embodiments, the antioxidants are present at a concentration of about 2 PHR.

When present, the dry weight concentration of stearic acid ranges from about 0.01 PHR to about 6 PHR, or from about 0.05 PHR to about 4 PHR, or from about 0.1 PHR to about 2 PHR, or from about 0.5 PHR to about 1.5 PHR. In particular embodiments, stearic acid is present at a concentration of about 1 PHR.

In particular embodiments, the common filler carbon black is replaced by waste filler. In some embodiments, the total filler loading does not exceed about 35 PHR. For example, where a filler-rubber composite comprises about 5 PHR waste filler the filler-rubber composite further comprises about 30 PHR carbon black.

Table A below displays general compounding formulations for filler-rubber composites.

TABLE A
General Compounding Formulations (all
units in parts per hundred rubber; PHR)

| | Formu- | Formu- | Formu- | Formu- |
|---|---|---|---|---|
| Ingredient | lation 1 | lation 2 | lation 3 | lation 4 |
| Rubber Component | 1-100 | 50-100 | 75-100 | 100 |
| Carbon Black | 34.9-0 | 34.9-0 | 34.9-0 | 34.9-0 |
| Filler | 0.1-35 | 0.1-35 | 0.1-35 | 0.1-35 |
| Sulfur | 0.5-10 | 1-8 | 1.5-5 | 2-4 |
| ZnO | 0.1-12 | 0.1-10 | 2-8 | 4-6 |
| TBBS | 0.01-5 | 0.1-2 | 0.2-1 | 0.5-1 |
| Stearic acid | 0.01-6 | 0.05-4 | 0.1-2 | 0.5-1.5 |

Further provided herein are rubber composites that include more than one rubber component. Table B below displays non-limiting examples of possible alternative compounding formulations that include more than one rubber component.

TABLE B
Alternative Compounding Formulations
(all units per hundred rubber; PHR)

| | Formu- | Formu- | Formu- | Formu- |
|---|---|---|---|---|
| Ingredient | lation 1 | lation 2 | lation 3 | lation 4 |
| First Rubber | 1-100 | 50-100 | 75-100 | 100 |
| Component | | | | |
| Second Rubber | 1-100 | 50-100 | 0-20 | 0 |
| Component | | | | |
| Carbon black | 30-0 | 25-0 | 20-0 | Approx. 30, |
| | | | | 25, 15, or 0 |
| Filler | 5-35 | 10-35 | 15-35 | Approx. 5.0, |
| | | | | 10.0, 20.0, or |
| | | | | 35.0 |
| Sulfur | 0.5-10 | 1-8 | 1.5-5 | Approx. 3.5 |
| ZnO | 0.1-12 | 0.1-10 | 2-8 | Approx. 5 |
| TBBS | 0.01-5 | 0.1-2 | 0.2-1 | Approx. 0.75 |
| Stearic acid | 0.01-6 | 0.05-4 | 0.1-2 | Approx. 1 |

Because the waste fillers can be milled and/or sieved to desirable sizes, various combinations of waste fillers and sizes are possible. Table C, below, displays some examples of specific types and sizes of waste fillers in specific rubber components. These are given by way of non-limiting example only; many other combinations are possible, and many other combinations are described as having been produced in the examples below.

TABLE C
Specific Combinations of Fillers and Sizes
(all units parts per hundred rubber, PHR)

| Formulation 1 | Formulation 2 | Formulation 3 |
|---|---|---|
| Hevea rubber | Guayule rubber | Synthetic rubber |
| Carbon black | Carbon black | Carbon black |
| Micro-sized | Micro-sized | Micro- or nano- |
| carbon fly ash, | guayule bagasse, | sized carbon fly |
| micro-sized | micro-sized | ash, micro- or |
| guayule bagasse, | tomato peel. | nano-sized |
| micro-sized | | eggshell, micro- or |
| tomato peel. | | nano-sized |
| | | guayule bagasse, |
| | | micro- or nano- |
| | | sized tomato peel. |
| Sulfur | Sulfur | Sulfur |
| ZnO | ZnO | ZnO |
| TBBS Accelerator | TBBS Accelerator | TBBS Accelerator |
| Stearic Acid | Stearic Acid | Stearic Acid |

In certain embodiments, a guayule filler-rubber composite comprises 5 PHR micro-sized carbon fly ash filler and 30 PHR carbon black. In another embodiment, a guayule filler-rubber composite comprises 10 PHR micro-sized carbon fly ash filler and 25 PHR carbon black. In yet another embodiment, a guayule filler -rubber composite comprises 20 PHR micro-sized carbon fly ash filler and 15 PHR carbon black. In still another embodiment, a guayule filler-rubber composite comprises 35 PHR micro-sized carbon fly ash filler and no carbon black.

In certain embodiments, a guayule filler-rubber composite comprises 5 PHR micro-sized eggshell filler and 30 PHR carbon black. In another embodiment, a guayule filler-rubber composite comprises 10 PHR micro-sized eggshell filler and 25 PHR carbon black. In yet another embodiment, a guayule filler -rubber composite comprises 20 PHR micro-sized guayule bagasse filler and 15 PHR carbon black. In still another embodiment, a guayule filler-rubber composite comprises 35 PHR micro-sized eggshell filler and no carbon black.

In certain embodiments, a guayule filler-rubber composite comprises 5 PHR micro-sized guayule bagasse filler and 30 PHR carbon black. In another embodiment, a guayule filler-rubber composite comprises 10 PHR micro-sized guayule bagasse filler and 25 PHR carbon black. In yet another embodiment, a guayule filler-rubber composite comprises 20 PHR micro-sized guayule bagasse filler and 15 PHR carbon black. In still another embodiment, a guayule filler-rubber composite comprises 35 PHR micro-sized guayule bagasse filler and no carbon black.

In certain embodiments, a guayule filler-rubber composite comprises 5 PHR micro-sized tomato peel filler and 30 PHR carbon black. In another embodiment, a guayule filler-rubber composite comprises 10 PHR micro-sized tomato peel filler and 25 PHR carbon black. In yet another embodiment, a tomato peel filler -rubber composite comprises 20 PHR micro-sized tomato peel filler and 15 PHR carbon black. In still another embodiment, a guayule filler-rubber composite comprises 35 PHR micro-sized tomato peel filler and no carbon black.

In certain embodiments, a Hevea filler-rubber composite comprises 5 PHR micro-sized carbon fly ash filler and 30 PHR carbon black. In another embodiment, a Hevea filler-rubber composite comprises 10 PHR micro-sized carbon fly ash filler and 25 PHR carbon black. In yet another embodiment, a Hevea filler-rubber composite comprises 20 PHR micro-sized carbon fly ash filler and 15 PHR carbon black. In still another embodiment, a Hevea filler-rubber composite comprises 35 PHR micro-sized carbon fly ash filler and no carbon black.

In certain embodiments, a Hevea filler-rubber composite comprises 5 PHR micro-sized eggshell filler and 30 PHR carbon black. In another embodiment, a Hevea filler-rubber composite comprises 10 PHR micro-sized eggshell filler and 25 PHR carbon black. In yet another embodiment, a Hevea filler-rubber composite comprises 20 PHR micro-sized Hevea bagasse filler and 15 PHR carbon black. In still another embodiment, a Hevea filler-rubber composite comprises 35 PHR micro-sized eggshell filler and no carbon black.

In certain embodiments, a Hevea filler-rubber composite comprises 5 PHR micro-sized guayule bagasse filler and 30 PHR carbon black. In another embodiment, a Hevea filler-rubber composite comprises 10 PHR micro-sized guayule bagasse filler and 25 PHR carbon black. In yet another embodiment, a Hevea filler-rubber composite comprises 20 PHR micro-sized guayule bagasse filler and 15 PHR carbon black. In still another embodiment, a Hevea filler-rubber composite comprises 35 PHR micro-sized guayule bagasse filler and no carbon black.

In certain embodiments, a Hevea filler-rubber composite comprises 5 PHR micro-sized tomato peel filler and 30 PHR carbon black. In another embodiment, a Hevea filler-rubber composite comprises 10 PHR micro-sized tomato peel filler and 25 PHR carbon black. In yet another embodiment, a tomato peel filler -rubber composite comprises 20 PHR micro-sized tomato peel filler and 15 PHR carbon black. In still another embodiment, a Hevea filler-rubber composite comprises 35 PHR micro-sized tomato peel filler and no carbon black.

As seen from the examples below and figures, many waste filler-rubber composites have stronger tensile properties. A reinforcing effect is seen with smaller particle sizes at lower loadings. Reduction of particle size increased ultimate elongation as well as stress at 500% elongation and tensile strength, while the increase of the filler load in the composite increased ultimate elongation but decreased stress at 500% elongation and tensile strength. The results presented herein demonstrate the ability to replace or decrease the use of existing fillers with sustainable equivalent materials capable of reproducing desirable and meeting product standards. The use of waste fillers can also decrease manufacturing costs.

It will be recognized by one having skill in the art that the various elements in the example compounding formulations presented herein may be substituted with comparable elements known in the art, or eliminated, in the compounding of a waste filler-rubber composite. Similarly, additional elements known in the art of rubber compounding, such as activators, release agents, plasticizers, softeners, age resistors, and processing agents. These alternative rubber composites, comprising at least one waste filler described herein, are within the scope of the present disclosure. One of skill in the art will recognize that alternative compounding formulations are desirable in order to achieve an end product filler-rubber composite having various desired characteristics.

Further, one of skill in the art will recognize that the filler-rubber composites described herein may be compounded using techniques well known in the art.

Fabricated Articles

The filler-rubber composites described herein are less expensive to produce and have advantageous physical performance characteristics. Therefore, the filler-rubber composites are useful in a wide variety of fabricated articles. By way of non-limiting example, the filler-rubber composites of the present disclosure may be fabricated into, or otherwise applied in the fabrication of: gaskets; seals; tires; hoses; tubing; vibration isolators; shock mounts; electrical components; medical components; conveyor belts; footwear; toys; and windshield wipers. Many other applications of the filler-rubber composite are envisioned and within the scope of the present disclosure.

Articles fabricated from filler-rubber composites may be fabricated in any of a variety of fabrication methods, including but not limited to compression molding, transfer molding, and injection molding. These techniques are well known in the art, and may be applied by one of skill in the art to the filler-rubber composites described herein.

In particular embodiments, a rubber gasket is fabricated from a filler-rubber composite described herein. In certain embodiments, the rubber gasket is appropriate for use with water, air, low-pressure steam, or a combination thereof. In another embodiment, a rubber gasket fabricated from a filler-rubber composite described herein exceeds the specifications of ASTM D 1330-04 (standard specification for rubber sheet gaskets—see Table H below). In yet another embodiment, a rubber gasket fabricated from a filler-rubber composite described herein possesses a tensile strength of at least 4.9 MPa, and an ultimate elongation of at least 150%. In yet other embodiments, a gasket is fabricated from a filler-rubber composite described herein by means of compression molding, transfer molding, or injection molding.

### EXAMPLES

### Example 1

### Waste Fillers

Various wastes were collected from food processing and agricultural industries, and were evaluated for their utility in downstream, value-added conversion to fillers of natural rubber composites. The fillers were evaluated two in two different natural rubber components: SMR-20 Hevea natural rubber; and guayule natural rubber. The Hevea natural rubber was purchased from Centrotrade US. The guayule natural rubber was prepared in-house according to known methods. Compounding chemicals zinc oxide, stearic acid, sulfur and the vulcanization accelerator TBBS, were purchased from H B chemicals (Twinsburg, Ohio). The fillers included eggshells (ES) from Troyer's Home Pantry (Apple Creek, Ohio), carbon fly ash (CFA) from Cargill Salt (Akron, Ohio), processing tomato peels (TP) from Hirzel Canning Co & Farms (Toledo, Ohio), and guayule bagasse (GB) generated from guayule plants obtained from PanAridus (Casa Grande, Ariz.).

Vegetable Wastes

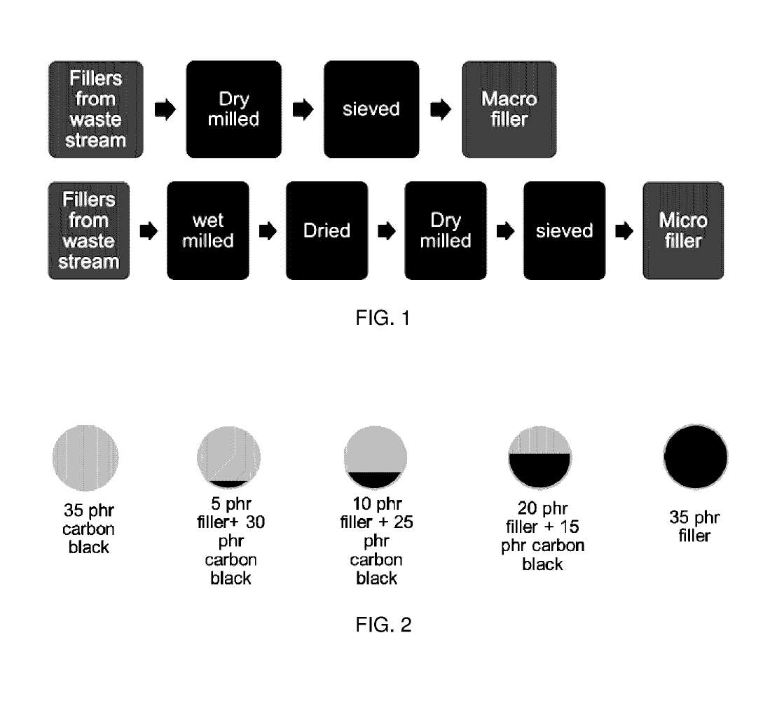

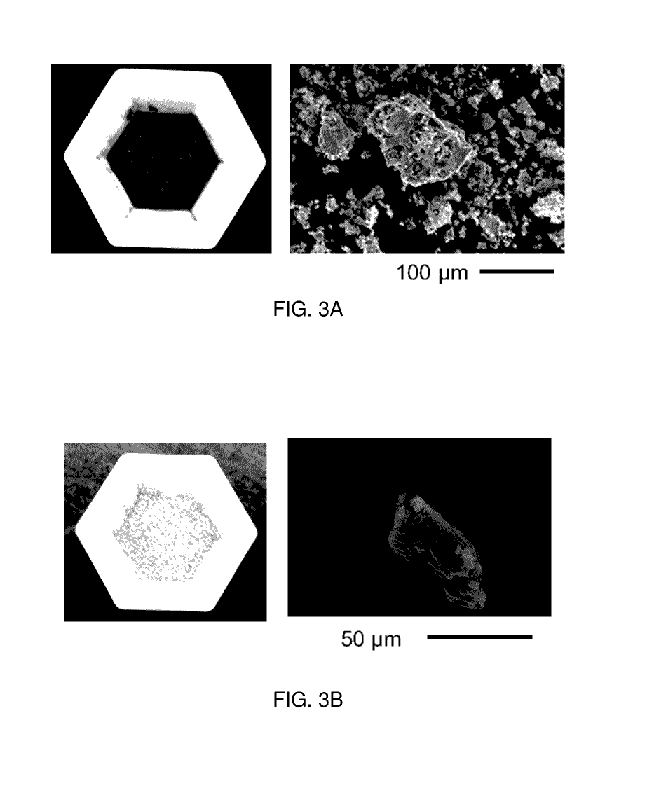

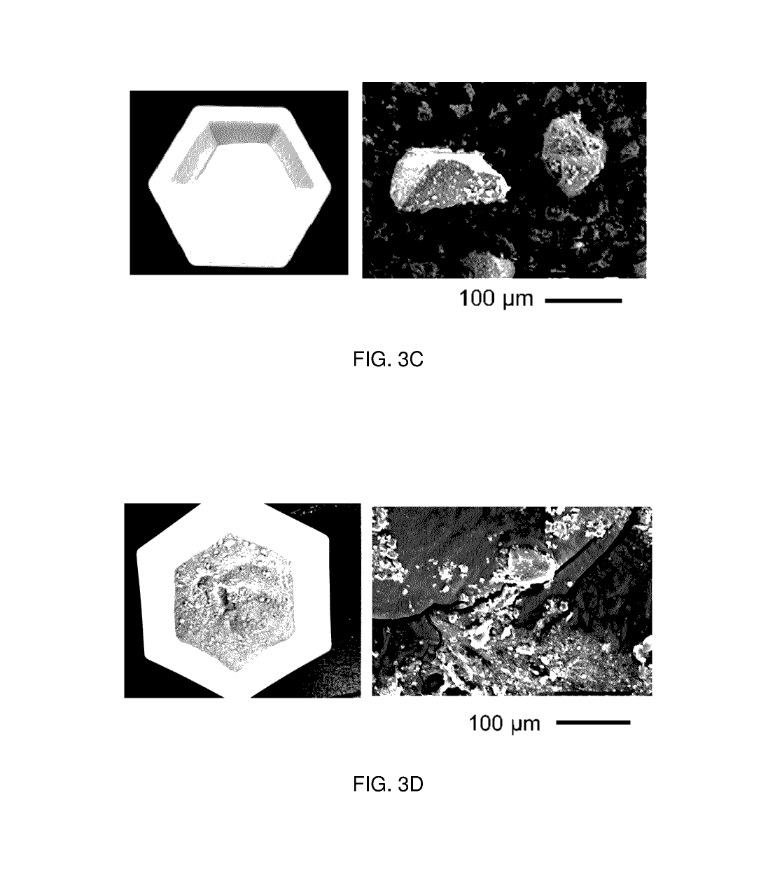

Tomato wastes were thawed at room temperature, if frozen, and all peels were dried at 50° C. in a convection oven for several days. The dried tomato wastes were ground using an IKA All basic mill (Wilmington, N.C.). Macro-sized particles were separated using a size 50 mesh sieve from Fisher Scientific (Pittsburgh, Pa.), with resulting particles ranging from 38 μm to 300 μm. Micro-sized particles were wet milled in water using a Planetary Ball Mill 100, Glen Mills (Clifton, N.J.), dried, then dry milled and sieved using a mesh size 400. Size ranges were confirmed using scanning and transmission microscopy. Tomato peel waste maintained a plate-like geometry in all sizes. See FIGS. 1 and 3D.

Mineral Wastes

Carbon fly ash (CFA) was supplied by Cargill Salt of Cargill, Inc. (Akron, Ohio). The CFA was processed in the same manner as the dried tomato wastes. The macro- and micro-CFA fillers possessed plate-like geometry whereas the nano-filler was more spherical in shape (FIG. 3A).

Calcium carbonate (CaCO₃) was derived from eggshells from store-bought white eggs, and white eggshells. The eggshells were soaked in hot water for 10 minutes, and the membranes were removed from the shells. The resulting CaCO₃ was processed in the same manner as the dried tomato wastes. All sizes maintained a plate-like geometry (FIG. 3C).

Lignocellulosic Wastes

Bark from guayule plants was removed from the branches, placed in ice water, sieved, and then blended in aqueous NH₄OH at pH 10, using a Waring blender. The resulting homogenate was pressed through eight layers of cheesecloth, and the remaining solids were dried at 50° C. for 24 h in a convection oven. The guayule bark bagasse (GB) was processed identically to the dried tomato wastes. The submicron geometry was a combination of fibrous and spherical particles (FIG. 3B).

Taraxacum kok-saghyz dandelion floss (DF) was harvested from field and high tunnel-grown plants. The DF was processed identically to the dried vegetable wastes.

Imaging

A Hitachi S-3500N scanning electron microscope (Tokyo, Japan) operated in a high vacuum was used to investigate the morphology of the different types of materials and dispersion of the filler within the polymer matrix. Cross sections of each composite sample at the fracture surface were cut and washed with an ethanol solution 70%, to eliminate surface contamination. The samples were sputter-coated with Platinum in order to improve their conductivity.

### Example 2

### Replacement of Carbon Black in Hevea Rubber Composites

Composite Preparation

The effect of different types of waste-derived fillers, particle size and filler loading, were determined in a standard Hevea compound formulation initially containing 35 PHR of carbon black and no other filler. Carbon black was gradually replaced by a specific waste-derived filler until no carbon black remained (Table D). Fillers and compounding ingredients were incorporated to the rubber through mastication using a Farrel BR lab mixer according to ASTM D3184, followed by milling of the rubber in a two-roll 6″×13″ EEMCO lab mill. The composites were cured as sheets with a thickness of 2 mm, at 16 tons of force, 1600 C during 12 min, using a 30 ton heated press, using an ASTM D3182 mold for 150 by 150 by 2 mm. After curing, the material was conditioned at room temperature for 24 hours prior to assessment of tensile properties.

Five sets of samples were prepared: standard Hevea compounds with 35 PHR carbon black, standard Hevea compounds with 5 PHR filler and 30 PHR carbon black, standard Hevea compounds with 10 PHR filler and 25 PHR carbon black, standard Hevea compounds with 20 PHR filler and 15 PHR carbon black, and standard Hevea compounds with 35 PHR filler and no carbon black. These filler loading combinations are depicted in FIG. 2. Otherwise, the standard compounds were compounded according to the formulation shown in Table D below. The fillers tested were carbon fly ash, eggshell, guayule bark bagasse, and tomato peel.

TABLE D
Compounding Formulation for Hevea Standard Compounds

| Material | Quantity (PHR) | | | | |
|---|---|---|---|---|---|
| Hevea NR | 100 | | | | |
| Carbon black | 35 | 30 | 25 | 15 | 0 |
| Filler | 0 | 5 | 10 | 20 | 35 |

| | |
|---|---|
| Sulfur | Approx. 3.5 |
| ZnO | Approx. 5 |
| TBBS | Approx. 0.75 |
| Stearic Acid | Approx. 1 |

Materials Characterization

Composite Testing

Five dumbbell specimens of each Hevea composite were cut using ASTM Die C. Tensile properties were measured along the grain direction, according to ASTM D412, using a tensiometer, Model 3366, Instron, (Norwood, Mass.), with a crosshead speed of 500 mm/min. Hardness evaluations were performed using a Type A Durometer following ASTM D 2240. Table E, below, displays the mechanical properties of the various Hevea filler-rubber composites tested. The resulting properties of these composites (stress at 300% elongation, tensile strength, elongation at break, and hardness) were compared.

Imaging

A Hitachi S-3500N scanning electron microscope (Tokyo, Japan) operated in a high vacuum was used to investigate the morphology of the different types of materials and dispersion of the filler within the polymer matrix. Cross sections of each composite sample at the fracture surface were cut and washed with an ethanol solution 70%, to eliminate surface contamination. The samples were sputter-coated with Platinum in order to improve their conductivity

Statistical Analysis

Cluster analysis was done in order to group composites with similar mechanical properties. In this multivariate analysis every sample was described by the results obtained in the different response properties. Euclidian distance was used to measure the similarity between the treatments. The Ward's method was used as the linkage method. Multiple means comparison, at a significance level a of 0.05, was performed, in order to further compare the resulting groups.

Tensile Properties of Hevea Filler-Rubber Composites

As the amount of non-carbon black fillers was increased in Hevea rubber, a decrease on the 300% modulus and tensile strength was observed for all the composites except those made with micro sized tomato peel (Table E). This behavior is due to the lower reinforcing effect of the non-carbon black fillers compared to carbon black. At low filler loading the reinforcing effect of carbon black predominated in the control of the properties over the other filler, but at high loadings the reinforcing effect depended only on the non-black filler. The lower reinforcing of non-black fillers is was due to differences in surface area and surface chemistry. Besides having the smallest particles (26-30 nm), hence more surface area, carbon black possesses a relatively non-polar surface, which is more compatible with NR than the more polar fillers like the cellulose in guayule bagasse and tomato peel.

Comparison of composites made using macro and micro size particles revealed higher values of 300% modulus and tensile strength achieved by Hevea rubber composites made with micro sized particles (Table E). Bigger particles not only possessed less surface area per unit weight, which decreased the reinforcing effect, but also generated flaws within the material. Despite the trend observed, composites manufactured with low loading (5 PHR) of carbon fly ash and eggshell and tomato peel presented very similar values of 300% modulus to those of composites made with carbon black, for both macro and micro sized particles. Furthermore, 300% modulus of composites containing 5 PHR micro sized carbon fly ash, eggshell, and tomato peel as well as 10 PHR micro sized tomato peel were not significant different from the mean 300% modulus of carbon black. Likewise, the composites with the highest tensile results were those containing 10 PHR of micro sized tomato peel and eggshell, and 5 PHR of macro sized eggshell, with tensile strengths of 31.76 MPa, 30.05 MPa and 29.63 MPa, respectively. These values were not significantly different among them, however; only 10 PHR of micro sized tomato peel was not significantly different from carbon black alone (34.24 MPa—Table E).

Elongation at break of the Hevea rubber composites increased as the amount of non-carbon black filler increased. This increase was due to weaker polymer-filler interaction existing between non-carbon black filler and the natural rubber. The decrease in the carbon black portion allowed more chain mobility and therefore a more stretchable material was obtained.

TABLE E
Tensile properties of Hevea natural rubber composites manufacture using micro
and macro sized particles obtained from different waste derived materials. Each value is the mean
of 5 samples.

| | | Waste | | | Elongation | | Tensile | | | |
|---|---|---|---|---|---|---|---|---|---|---|
| Filler | | filler^{a} | Modulus | | at Break | | Strength | | Hardness | |
| Type | Size | (PHR) | at 300% | S.E. | (%) | S.E. | (MPa) | S.E. | number | S.E. |
| Control* | | 0 | 5.83 | 0.09 | 1,283 | 0.20 | 34.24 | 0.29 | | |
| CFA | 300 | 5 | 5.10 | 0.04 | 853 | 0.55 | 19.57 | 1.52 | 60 | 0.74 |
| CFA | 300 | 10 | 4.73 | 0.04 | 956 | 0.54 | 20.82 | 1.41 | 56 | 1.02 |
| CFA | 300 | 20 | 3.88 | 0.02 | 798 | 0.59 | 13.60 | 1.44 | 52 | 0.72 |
| CFA | 300 | 35 | 2.16 | 0.05 | 1,442 | 0.22 | 14.87 | 0.60 | 47 | 0.35 |
| Control* | | 0 | 5.83 | 0.09 | 1,283 | 0.20 | 34.24 | 0.29 | | |
| CFA | 38 | 5 | 5.65 | 0.06 | 1,278 | 0.14 | 28.80 | 0.42 | 59 | 1.02 |
| CFA | 38 | 10 | 5.31 | 0.20 | 1,251 | 0.30 | 27.04 | 0.90 | 57 | 0.31 |
| CFA | 38 | 20 | 4.39 | 0.12 | 1,433 | 0.14 | 27.49 | 0.34 | 53 | 0.52 |
| CFA | 38 | 35 | 2.70 | 0.05 | 1,526 | 0.29 | 22.09 | 0.53 | 46 | 0.43 |
| Control* | | 0 | 5.83 | 0.09 | 1,283 | 0.20 | 34.24 | 0.29 | | |
| Bagasse | 300 | 5 | 5.24 | 0.03 | 1,156 | 0.18 | 25.87 | 0.46 | 57 | 0.96 |
| Bagasse | 300 | 10 | 4.53 | 0.04 | 1,201 | 0.28 | 22.09 | 0.95 | 56 | 1.01 |
| Bagasse | 300 | 20 | 3.61 | 0.07 | 1,282 | 0.17 | 17.95 | 0.42 | 50 | 0.43 |
| Bagasse | 300 | 35 | 2.48 | 0.02 | 1,442 | 0.34 | 13.21 | 0.47 | 50 | 0.48 |
| Control* | | 0 | 5.83 | 0.09 | 1,283 | 0.20 | 34.24 | 0.29 | | |
| Bagasse | 38 | 5 | 4.05 | 0.04 | 1,292 | 0.15 | 27.23 | 0.36 | 58 | 0.48 |
| Bagasse | 38 | 10 | 3.39 | 0.03 | 1,367 | 0.04 | 24.69 | 0.21 | 55 | 0.66 |
| Bagasse | 38 | 20 | 1.90 | 0.38 | 1,491 | 0.83 | 17.40 | 0.54 | 52 | 1.03 |
| Bagasse | 38 | 35 | 3.01 | 0.03 | 1,480 | 0.12 | 18.19 | 0.28 | 49 | 0.35 |
| Control* | | 0 | 5.83 | 0.09 | 1,283 | 0.20 | 34.24 | 0.29 | | |
| Eggshell | 300 | 5 | 5.10 | 0.08 | 1,234 | 0.21 | 29.63 | 0.32 | 55 | 1.28 |
| Eggshell | 300 | 10 | 4.48 | 0.17 | 1,306 | 0.18 | 26.60 | 0.72 | 51 | 1.18 |
| Eggshell | 300 | 20 | 2.86 | 0.02 | 1,450 | 0.25 | 22.11 | 0.40 | 50 | 0.63 |
| Eggshell | 300 | 35 | 1.88 | 0.01 | 1,662 | 0.29 | 18.61 | 0.54 | 43 | 0.66 |
| Control* | | 0 | 5.83 | 0.09 | 1,283 | 0.20 | 34.24 | 0.29 | | |
| Eggshell | 38 | 5 | 5.54 | 0.04 | 1,154 | 0.23 | 28.99 | 0.23 | 56 | 0.52 |
| Eggshell | 38 | 10 | 4.50 | 0.08 | 1,396 | 0.31 | 30.05 | 0.50 | 55 | 0.48 |
| Eggshell | 38 | 20 | 3.46 | 0.12 | 1,521 | 0.26 | 28.72 | 1.14 | 50 | 0.63 |
| Eggshell | 38 | 35 | 2.26 | 0.06 | 1,173 | 0.54 | 11.73 | 1.03 | 49 | 0.52 |
| Control* | | 0 | 5.83 | 0.09 | 1,283 | 0.20 | 34.24 | 0.29 | | |
| Tomato | 300 | 5 | 4.36 | 0.06 | 1,265 | 0.34 | 27.24 | 0.55 | 62 | 0.55 |
| Tomato | 300 | 10 | 2.92 | 0.02 | 1,265 | 0.25 | 19.64 | 0.44 | 48 | 0.54 |
| Tomato | 300 | 20 | 2.79 | 0.02 | 1,162 | 0.12 | 14.38 | 0.23 | 56 | 0.63 |
| Control* | | 0 | 5.83 | 0.09 | 1,283 | 0.20 | 34.24 | 0.29 | | |
| Tomato | 38 | 5 | 5.32 | 0.08 | 1,123 | 0.17 | 28.27 | 0.33 | 60 | 0.24 |
| Tomato | 38 | 10 | 6.65 | 0.10 | 1,130 | 0.23 | 31.76 | 0.35 | 52 | 0.66 |

^{a}Table reports the amount of non-carbon black filler in the sample. Total amount of filler (carbon black plus non-carbon black), in all samples was 35 PHR.
*A composite made using 35 PHR or carbon black was used as control.

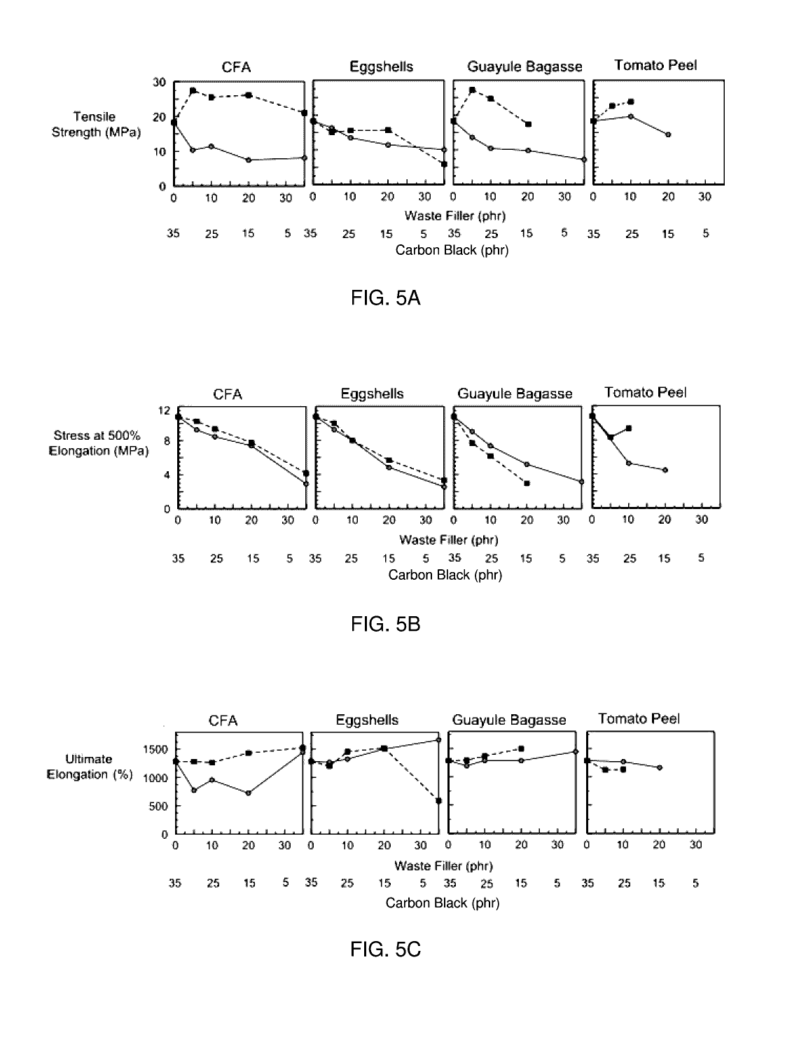

FIGS. 5A-5C show line graphs depicting the effects on tensile strength (MPa), stress at 500% elongation (MPa), and ultimate elongation (%) of various loadings of waste fillers in Hevea filler-rubber composites. All results in FIG. 5 were obtained from filler-rubber composites made with filler particles having a filler particle size of 38 μm or less.

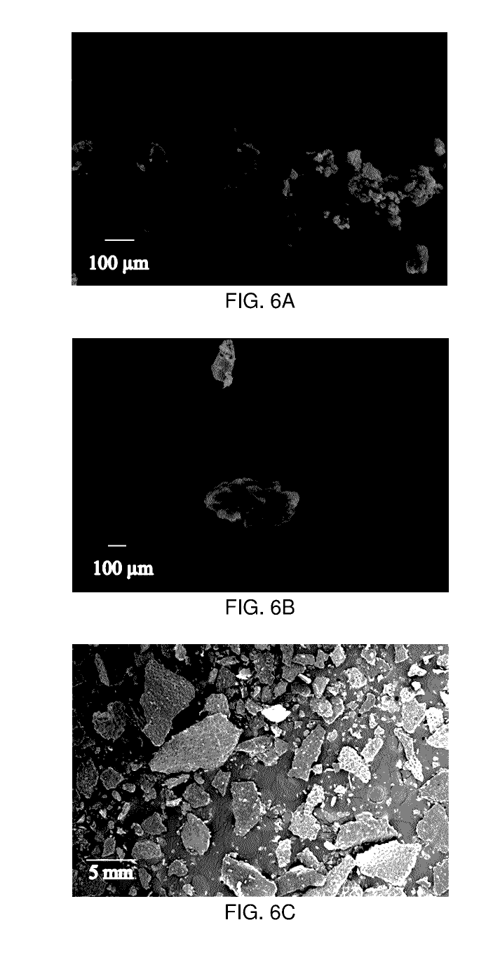

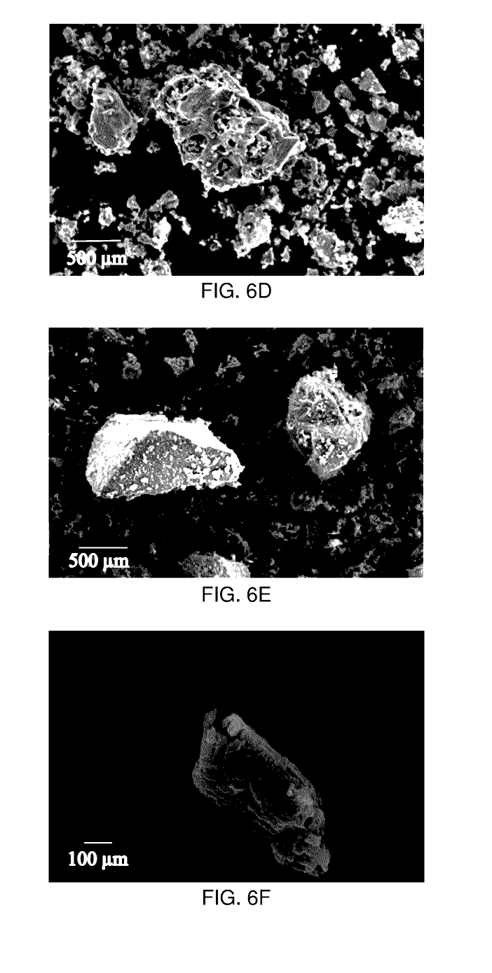

Composites made by partially replacing carbon black with tomato peel, presented similar reinforcing effect to carbon black due to similarities in particle structure. At a micro scale tomato peel particles are in the form of agglomerates of small granules (FIG. 6A), similar to carbon black structure (FIG. 6B). This particle structure is unique to this two fillers among the fillers used in this study (FIG. 6), and contributes to the reinforcing of the materials due to a combination of small particle size along with a high degree of irregularity that determines the restriction of the chain motion under the apply strain. This behavior is not observed in macro size tomato peel particles because at this larger scale the material presents a laminar shape (FIG. 6C) and possess less surface are.

The structure of the mineral fillers used, also influenced their reinforcing effect. Eggshell and carbon fly ash particles possessed a high surface area due to roughness and porosity of the materials (FIGS. 6D-6E). Eggshell porosity is the consequence of naturally occurring gas exchange pores. The porosity promoted a wetting effect that provided better interfacial adhesion between the polymer and the filler.

Naturally occurring resins in guayule bagasse had an impact on the final mechanical properties of the composites. These resins added a plasticizing effect, which increased the ductility of the material.

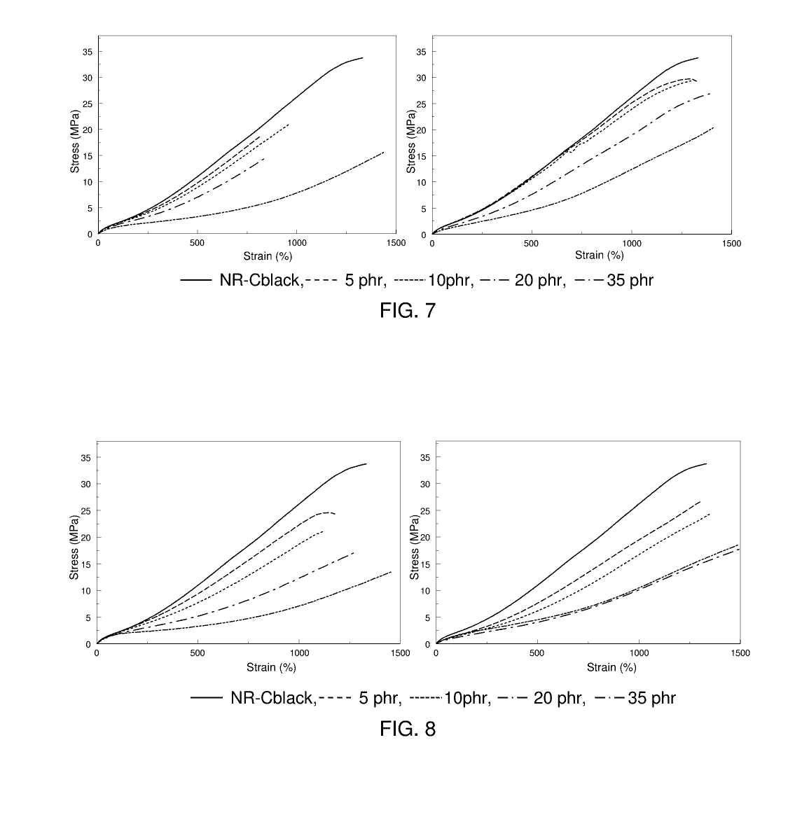

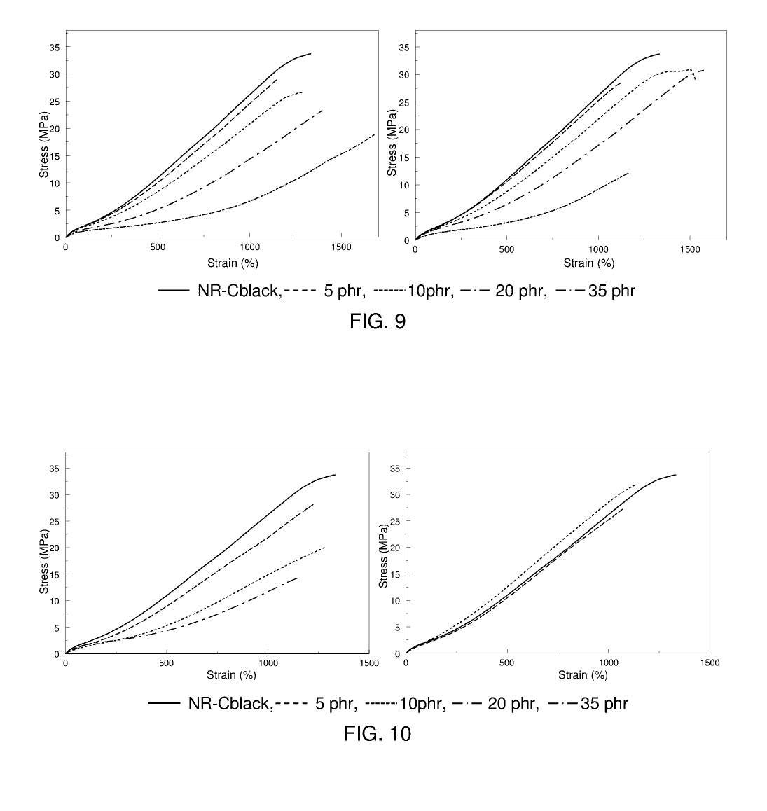

Stress versus strain curves are plotted in FIGS. 7-10, for Hevea composites made with macro particle size (left plots) and micro particle size (right plots). As the amount of non-carbon black filler was increased, the Hevea composites behaved more like a non-reinforced vulcanized rubber. The stress only increased slightly due to load transfer during chain rearrangement as evinced by the uniform increase on strain. Typical strain-induced crystallization also is observed in composites containing only non-carbon black fillers at elongation greater that 700%.

The results indicated that some reinforcing effect was obtained at low loadings (5 and 10 PHR) of micro sized non-black fillers, especially carbon fly ash, eggshell, and tomato peel, with reinforcement effects being higher than with carbon black alone. Hevea rubber composites manufactured by partially replacing carbon black with these materials showed tensile properties at least comparable, and often greater, to those of carbon black composites. This is important considering the renewable character of these materials, which carbon black lacks.

Analysis of Hevea Composite Morphology

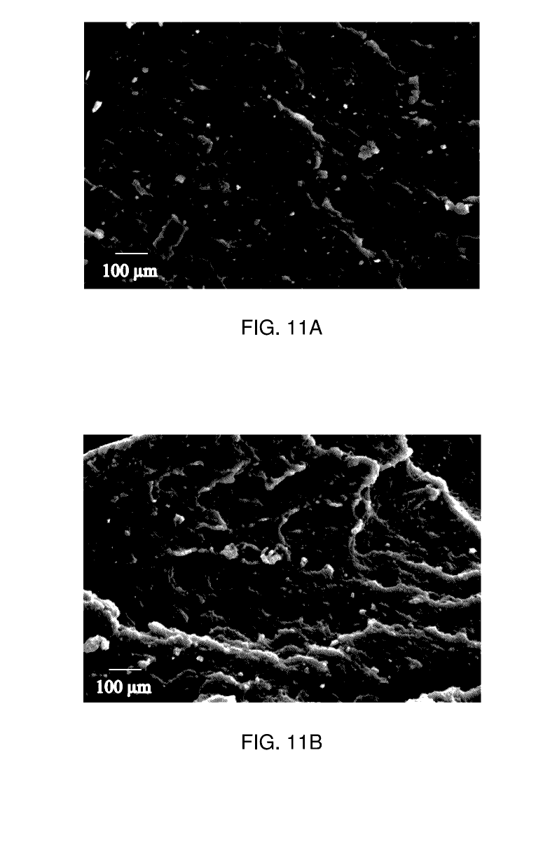

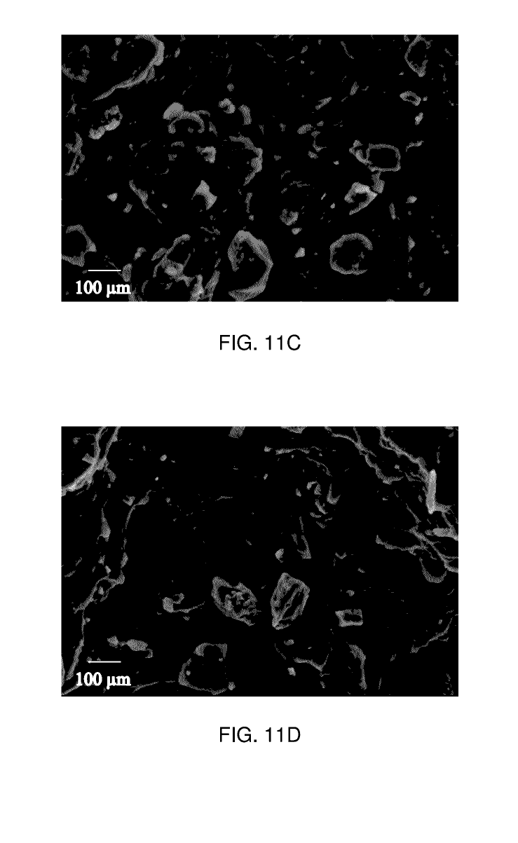

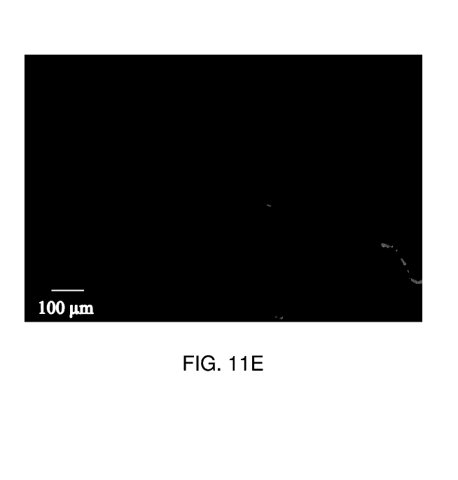

Hevea composites' morphology evidenced the differences in interfacial interactions between Hevea natural rubber and the various types of filler studied (FIG. 11). Carbon black Hevea composites (FIG. 11A) presented a uniform surface, with no agglomerations of the filler nor gaps within the polymer matrix being observed. This morphology was due to the good dispersion and filler-polymer interaction which, in the case of carbon black, is mainly physical in nature (van der Waals forces). Carbon black behaved as an additional crosslinker of the natural rubber network, which conferred the final mechanical properties to the composites.

Morphology observed in micrograph of micro sized tomato peel (FIG. 11B), confirmed the existence of similarities between carbon black and tomato peel Hevea composites and further explained resulting mechanical properties. In contrast, the presence of several gaps within the composites and smooth surfaces around the filler evidenced poor interfacial adhesion of the Hevea polymer with the other fillers.

Statistical Analysis

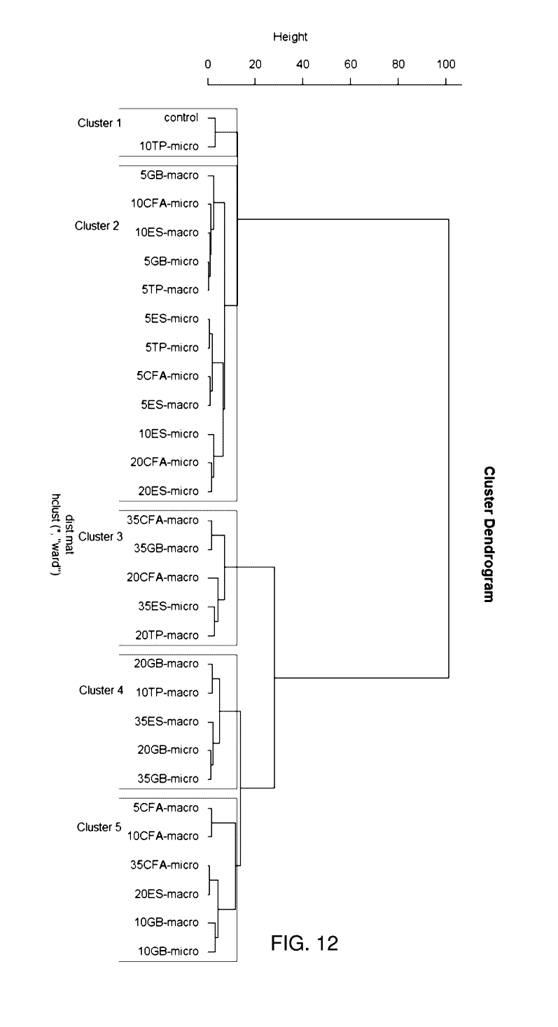

A distance level of 12 was used to divide a dendrogram into six homogeneous classes with common characteristics (FIG. 12). Cluster 1 includes composites made with carbon black and 10 PHR micro sized tomato peel. Samples in this cluster possessed the highest tensile strength and 300% modulus, and middle values of elongation at break. Cluster 2 groups the largest number of samples. Nearly 70% of the samples in this cluster contained micro size particles at low loading (5 and 10 PHR). These samples presented high tensile strength and 300% modulus (not as high as cluster 1) and middle to high values of elongation at break. Based on the mechanical properties, this cluster is more similar to cluster 1 than the other clusters. Multiple mean comparisons performed for the response variable tensile strength indicated that there is not a significant difference between the mean tensile strength of composites in clusters 1 and 2. The analysis also showed no significant difference between the mean tensile strength of composites containing 10 PHR of micro size tomato peel and composites in cluster 2. However, there is a significant different between the mean tensile strength of composites made with carbon black and composites in cluster 2.

Cluster 3 groups composites manufactured using macro size particles at high loadings (20 and 35 PHR). The samples possessed the lowest tensile strength, lowest modulus, and middle to high values of elongation at break. Cluster 4 and 5 gather composites that showed middle values of tensile strength, middle to low values of 300% modulus, and middle to high values of elongation at break. Approximately 64% of the composites in these groups were made using 10 PHR and 20 PHR of macro size particles.

Although the different fillers were scattered among the different clusters, 75% of composites made with the two mineral fillers (eggshell and carbon fly ash), were grouped in clusters 2 and 5 that included samples with high to middle values of tensile strength and 300% modulus. The clustering of the organic materials was mostly influenced by filler loading; composites containing loadings of 5 and 10 PHR were grouped in clusters 2 and 5, while composites containing 20 and 35 PHR were placed in clusters 3 and 4.

### Example 3

### Replacement of Carbon Black in Guayule Rubber Composites

Composite Preparation

The effect of different types of waste-derived fillers, particle size and filler loading, were determined in a standard guayule compound formulation initially containing 35 PHR of carbon black and no other filler. Carbon black was gradually replaced by a specific waste-derived filler until no carbon black remained (Table F). Fillers and compounding ingredients were incorporated to the guayule rubber similarly to Hevea, described in Example 2.

Five sets of samples were prepared: standard guayule compounds with 35 PHR carbon black, standard guayule compounds with 5 PHR filler and 30 PHR carbon black, standard guayule compounds with 10 PHR filler and 25 PHR carbon black, standard guayule compounds with 20 PHR filler and 15 PHR carbon black, and standard guayule compounds with 35 PHR filler and no carbon black. These filler loading combinations are depicted in FIG. 2. Otherwise, the standard compounds were compounded according to the formulation shown in Table F below. Guayule natural rubber may be further optimized by removing stearic acid from the compound, utilizing higher levels of sulfur, utilizing higher levels of accelerator TBSS, adding a second accelerator, or combinations thereof.

The fillers tested were carbon fly ash, eggshell, guayule bark bagasse, and tomato peel.

TABLE F
Compounding Formulation for Guayule Standard Compounds

| Material | Quantity (PHR) | | | | |
|---|---|---|---|---|---|
| Guayule NR | 100 | | | | |
| Carbon black | 35 | 30 | 25 | 15 | 0 |
| Filler | 0 | 5 | 10 | 20 | 35 |

| | |
|---|---|
| Sulfur | Approx. 3.5 |
| ZnO | Approx. 5 |
| TBBS | Approx. 0.75 |
| Stearic Acid | Approx. 1 |

Materials Characterization

Composite Testing

Five dumbbell specimens of each guayule composite were cut using ASTM Die C. Tensile properties were measured along the grain direction, according to ASTM D412, using a tensiometer, Model 3366, Instron, (Norwood, Mass.), with a crosshead speed of 500 mm/min Hardness evaluations were performed using a Type A Durometer following ASTM D 2240. Table G, below, displays the mechanical properties of the various guayule filler-rubber composites tested. The resulting properties of these composites (stress at 300% elongation, tensile strength, elongation at break, and hardness) were compared.

Tensile Properties of Guayule Filler-Rubber Composites

As the amount of non-carbon black fillers was increased in guayule rubber, a decrease on the 300% modulus and tensile strength was observed for all the composites except those made with micro-sized eggshell (Table G). However, many of the fillers at low loading increased the 300% modulus and tensile strength compared to control. These fillers included micro-sized eggshell (5 and 10 PHR), macro-sized guayule bagasse (5 and 10 PHR), micro-sized guayule bagasse (5 PHR), macro and micro-sized carbon fly ash (5 PHR), macro-sized tomato peel (5 and 10 PHR), and micro-sized tomato peel (5 PHR).

Comparison of composites made using macro and micro size particles revealed similar values of 300% modulus in guayule rubber composites made with macro- and micro-sized particles, while micro-sized particles resulted in guayule rubber composites having higher tensile strength (Table G). Guayule composites manufactured with low loading (5 PHR) of carbon fly ash and eggshell and tomato peel presented greater values of 300% modulus to those of composites made with carbon black, for both macro and micro sized particles, except for eggshell, where values were similar. Micro-sized eggshell, at a slightly higher loading (10 PHR), presented a greater value than the control.

The composites with the highest tensile results were those containing 15 and 10 PHR micro-sized eggshell (25.19 MPa and 26.56 MPa, respectively), those containing 5 PHR macro-sized guayule bagasse or carbon fly ash (26.28 MPa and 22.01 MPa, respectively), and those containing 5 PHR micro-sized eggshell, carbon fly ash, or tomato peel (26.55 MPa, 24.05 MPa, and 25.79 MPa, respectively) (Table G).

Elongation at break of the guayule rubber composites tended to increase as the amount of non-carbon black filler increased.

TABLE G
Tensile properties of guayule natural rubber composites manufacture using
micro and macro sized particles obtained from different waste derived materials. Each value is the
mean of 5 samples.

| | | Waste | | | Elongation | | Tensile | | | |
|---|---|---|---|---|---|---|---|---|---|---|
| Filler | | filler^{a} | Modulus | | at Break | | Strength | | Hardness | |
| Type | Size | (PHR) | at 300% | S.E. | (%) | S.E. | (MPa) | S.E. | number | S.E. |
| Control* | | 0 | 2.78 | 0.15 | 1394.74 | 0.13 | 21.29 | 0.75 | | |
| Eggshell | 300 | 5 | 2.72 | 0.03 | 1579.35 | 0.22 | 21.64 | 0.07 | 53.38 | 0.69 |
| Eggshell | 300 | 10 | 2.56 | 0.05 | 1703.04 | 0.27 | 22.18 | 0.67 | 48.63 | 0.77 |
| Eggshell | 300 | 20 | 1.85 | 0.01 | 1806.25 | 0.08 | 18.01 | 0.13 | 43.13 | 0.43 |
| Eggshell | 300 | 35 | 1.25 | 0.01 | 1819.69 | 0.27 | 12.90 | 0.39 | 36.75 | 0.48 |
| Control* | | 0 | 2.78 | 0.15 | 1394.74 | 0.13 | 21.29 | 0.75 | | |
| Eggshell | 38 | 5 | 2.47 | 0.03 | 2041.20 | 0.30 | 26.55 | 0.14 | 49.50 | 0.35 |
| Eggshell | 38 | 10 | 2.97 | 0.12 | 1835.80 | 0.34 | 26.56 | 0.82 | 50.50 | 0.84 |
| Eggshell | 38 | 20 | 1.90 | 0.06 | 2243.48 | 0.17 | 25.19 | 0.72 | 40.50 | 0.87 |
| Eggshell | 38 | 35 | 1.39 | 0.01 | 2028.98 | 0.39 | 14.56 | 0.51 | 34.38 | 0.24 |
| Control* | | 0 | 2.78 | 0.15 | 1394.74 | 0.13 | 21.29 | 0.75 | | |
| Bagasse | 300 | 5 | 3.71 | 0.01 | 1521.19 | 0.21 | 26.28 | 0.41 | 48.75 | 0.32 |
| Bagasse | 300 | 10 | 3.26 | 0.05 | 1280.76 | 0.09 | 21.01 | 0.28 | 51.00 | 0.41 |
| Bagasse | 300 | 20 | 1.90 | 0.01 | 1574.78 | 0.20 | 14.73 | 0.28 | 45.50 | 0.35 |
| Bagasse | 300 | 35 | 1.19 | 0.01 | 1703.86 | 0.18 | 9.17 | 0.15 | 39.13 | 0.35 |
| Control* | | 0 | 2.78 | 0.15 | 1394.74 | 0.13 | 21.29 | 0.75 | | |
| Bagasse | 38 | 5 | 2.81 | 0.05 | 1528.11 | 0.14 | 22.72 | 0.44 | 52.13 | 0.47 |
| Bagasse | 38 | 10 | 2.36 | 0.01 | 1533.87 | 0.08 | 18.79 | 0.11 | 51.88 | 0.32 |
| Bagasse | 38 | 20 | 2.00 | 0.03 | 1551.48 | 0.09 | 15.05 | 0.17 | 42.38 | 0.24 |
| Bagasse | 38 | 35 | 1.67 | 0.03 | 1638.92 | 0.19 | 11.32 | 0.24 | 41.50 | 0.20 |
| Control* | | 0 | 2.78 | 0.15 | 1394.74 | 0.13 | 21.29 | 0.75 | | |
| CFA | 300 | 5 | 3.55 | 0.14 | 1421.77 | 0.42 | 22.01 | 0.45 | 53.13 | 1.23 |
| CFA | 300 | 10 | 2.52 | 0.01 | 1614.04 | 0.16 | 19.99 | 0.22 | 45.75 | 0.52 |
| CFA | 300 | 20 | 1.93 | 0.02 | 1855.15 | 0.12 | 19.59 | 0.39 | 37.00 | 0.46 |
| CFA | 300 | 35 | 0.96 | 0.01 | 2325.92 | 0.14 | 12.35 | 0.19 | 27.63 | 1.07 |
| Control* | | 0 | 2.78 | 0.15 | 1394.74 | 0.13 | 21.29 | 0.75 | | |
| CFA | 38 | 5 | 3.18 | 0.04 | 1471.76 | 0.14 | 24.05 | 0.26 | 52.00 | 1.34 |
| CFA | 38 | 10 | 2.78 | 0.06 | 1342.18 | 0.49 | 18.37 | 0.89 | 54.75 | 0.52 |
| CFA | 38 | 20 | 1.74 | 0.06 | 1688.05 | 0.28 | 16.55 | 0.41 | 45.88 | 1.15 |
| CFA | 38 | 35 | 1.28 | 0.01 | 2048.21 | 0.09 | 16.60 | 0.25 | 38.63 | 0.69 |
| Control* | | 0 | 2.78 | 0.15 | 1394.74 | 0.13 | 21.29 | 0.75 | | |
| Tomato | 300 | 5 | 3.44 | 0.04 | 1233.31 | 0.12 | 20.41 | 0.23 | 57.88 | 0.43 |
| Tomato | 300 | 10 | 3.22 | 0.09 | 1396.90 | 0.17 | 22.38 | 0.67 | 53.13 | 0.52 |
| Tomato | 300 | 20 | 2.16 | 0.04 | 1307.15 | 0.13 | 14.21 | 0.12 | 50.00 | 0.46 |
| Tomato | 300 | 35 | 0.82 | 0.01 | 1489.11 | 0.43 | 5.92 | 0.45 | 34.75 | 0.25 |
| Control* | | 0 | 2.78 | 0.15 | 1394.74 | 0.13 | 21.29 | 0.75 | | |
| Tomato | 38 | 5 | 3.05 | 0.02 | 1565.43 | 0.04 | 25.79 | 0.08 | 54.88 | 1.30 |
| Tomato | 38 | 10 | 2.45 | 0.01 | 1584.31 | 0.18 | 21.55 | 0.34 | 46.63 | 0.24 |
| Tomato | 38 | 20 | 1.93 | 0.03 | 1757.85 | 0.13 | 21.55 | 0.20 | 44.38 | 0.24 |
| Tomato | 38 | 35 | 1.15 | 0.01 | 2293.88 | 0.31 | 18.72 | 0.47 | 39.63 | 0.24 |

^{a}Table reports the amount of non-carbon black filler in the sample. Total amount of filler (carbon black plus non-carbon black), in all samples was 35 PHR.
*A composite made using 35 PHR or carbon black was used as control.

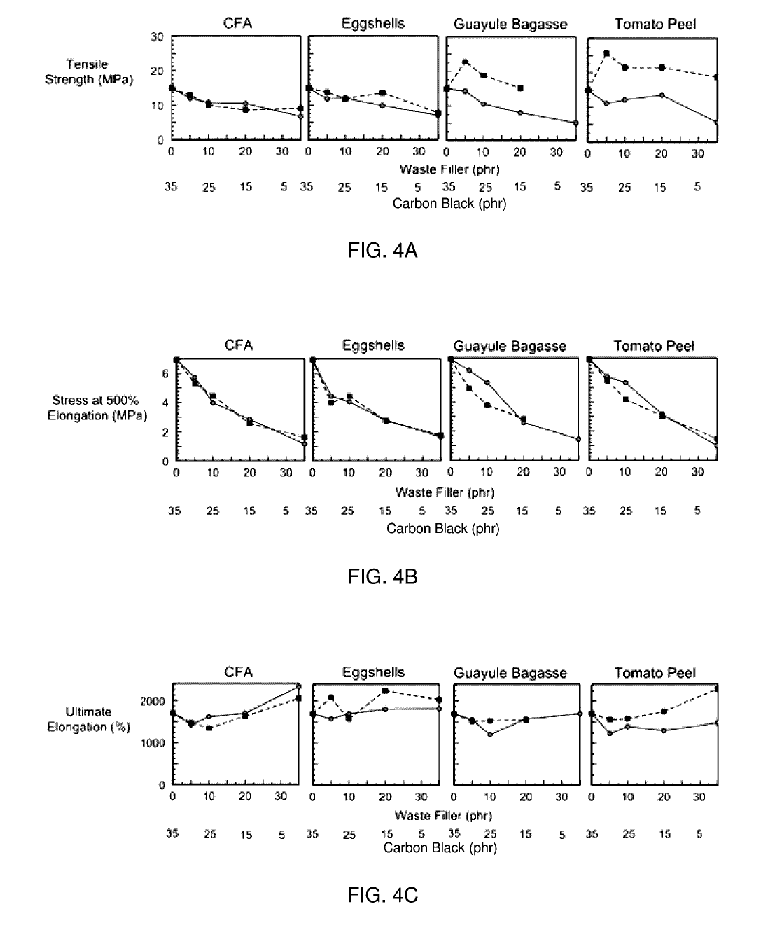

FIGS. 4A-4C show line graphs depicting the effects on tensile strength (MPa), stress at 500% elongation (MPa), and ultimate elongation (%) of various loadings of waste fillers in Hevea filler-rubber composites. All results in FIG. 4 were obtained from filler-rubber composites made with filler particles having a filler particle size of 38 μm or less.

### Example 4

### Hardness of Havea and Guayule Rubber Composites

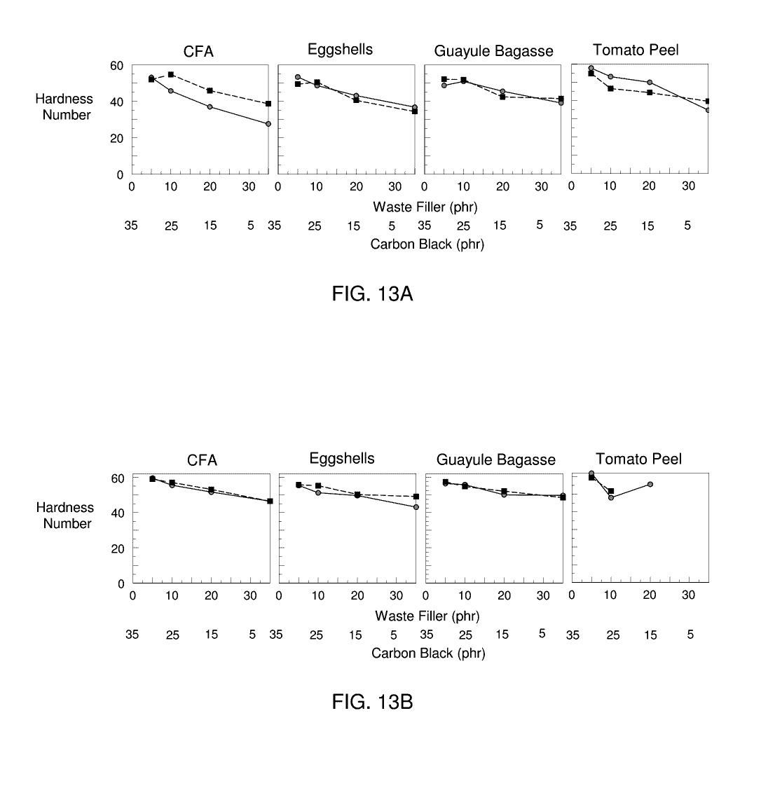

FIGS. 13A-13B show line graphs depicting the effects on hardness number (as determined using a Type A Durometer following ASTM D 2240) of various loadings of waste fillers in guayule filler-rubber composites (FIG. 13A) or Hevea filler-rubber composites (FIG. 13B).

These data showed that many of the filler-rubber compounds tested met or exceeded the ASTM standard specification for rubber sheet gaskets (ASTM D1330 -04), which is presented in Table H, below.

TABLE H
ASTM D1330 - 04 - Standard Specification
for Rubber Sheet Gaskets

| | Tensile Strength | Ultimate Elongation | Hardness |
|---|---|---|---|
| Contac Media | (MPa) | (%) | Number |
| Water | 4.9 min | 150 min | 70-85 |
| Air | 2.8 min | 150 min | 70-85 |
| Low-Pressure Steam | 4.9 min | 150 min | 70-85 |

The rubber compounds tested and described herein largely had stronger tensile properties with smaller particle sizes at lower loadings. Reduction of particle size increased ultimate elongation as well as stress at 300% elongation and tensile strength, while the increase of the filler load in the compound increased ultimate elongation but decreased stress at 300% elongation and tensile strength. These results showed that existing fillers can be replaced with sustainable waste-based fillers, which are capable of reproducing desirable properties, meeting product standards, and lowering production costs.

Certain embodiments of the filler-rubber composites, and methods disclosed herein are described in the above specification and examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the compositions and methods described herein to various usages and conditions. Various changes may be made and equivalents may be substituted for elements thereof without departing from the essential scope of the disclosure. In addition, many modifications may be made to adapt a particular situation or material to the teachings of the disclosure without departing from the essential scope thereof.

1. A rubber composite comprising:
a) a rubber component selected from the group consisting of: a natural rubber component; and a synthetic rubber component;
b) a crosslinking system;
c) one or more accelerators;
d) one or more activators;
e) a filler comprising vegetable waste, mineral waste, lignocellulosic waste, tomato peel, eggshell, or a combination thereof;
f) and no more than about 0-30 PHR carbon black.

2. (canceled)

3. (canceled)

4. The rubber composite of claim 1, wherein the filler comprises micro-sized particles having an average particle size of from; about 1 μm to about 38 μm; tomato peel, eggshell; or, less than about 1 μm.

5. (canceled)

6. (canceled)

7. (canceled)

8. The rubber composite of claim 1, wherein the rubber component is a natural rubber component selected from the group consisting of: Hevea natural rubber; guayule natural rubber; and Tarazacum kok-saghyz (TKS) natural rubber.

9. (canceled)

10. The rubber composite of claim 1, wherein the one or more accelerators comprises TBBS, ZDEC, DPG, Sulfads®, or a combination thereof.

11. The rubber composite of claim 1, wherein the vegetable waste is selected from the group consisting of: tomato peel; tomato paste; potato peel; onion peel; lemon peel; tangerine peel; banana peel; and kiwi peel.

12. The rubber composite of claim 1, wherein the mineral waste is selected from the group consisting of: carbon fly ash; eggshell; bauxite residues; drilling debris; aluminum dross; cement waste; coal mine schist; geological mine tailings; sewage sludge ash; sludge solids; steel slag; zeolites; zinc slag; polyhydroxy butrate valerate (PHBV); starch-based plastics; polylactic acid (PLA); poly-3-hydroxybutyrate (PHB); poly-3-hydroxyalkanoate (PHA); polyamide 11 plastics; and floss.

13. (canceled)

14. The rubber composite of claim 1, wherein the lignocellulosic waste is selected from the group consisting of: guayule bagasse; Tarazacum kok-saghyz floss; paper sludge; cardboard; straw; sawdust; and pine bark.

15. (canceled)

16. (canceled)

17. (canceled)

18. (canceled)

19. The rubber composite of claim 1, wherein the activator comprises one or more of: stearic acid; ZnO; and antioxidants.

20. (canceled)

21. (canceled)

22. The rubber composite of claim 1, wherein the filler and carbon black are present in the rubber composite about 35 PHR, total.

23. The rubber composite of claim 10, wherein the filler is present in the rubber composite at about 5 PHR to about 30 PHR and wherein the carbon black is present in the rubber composite at about 30 PHR to about 0.1 PHR.

24. (canceled)

25. (canceled)

26. (canceled)

27. (canceled)

28. (canceled)

29. (canceled)

30. The rubber composite of claim 1, wherein the crosslinking system is selected from the group consisting of: a sulfur crosslinking system; a peroxide crosslinking system; a urethane crosslinking system; a metallic oxide crosslinking system; an acetoxysilane crosslinking system; and a radiation-based crosslinking system.

31. (canceled)

32. A method of making a rubber composite comprising compounding a natural rubber component wherein the natural rubber component is selected from the group consisting of: Hevea natural rubber; guayule natural rubber; and Tarazacum kok-saghyz (TKS) natural rubber, a synthetic rubber component, or a mixture thereof, with at least one filler selected from the group consisting of: carbon fly ash; guayule bagasse; eggshell; and tomato peel; and adding one or more: a crosslinking system; accelerators; activators; plasticizers; softeners; carbon black present at no more than about 30 PHR; silica; and processing agents.

33. (canceled)

34. (canceled)

35. (canceled)

36. (canceled)

37. (canceled)

38. The method of claim 32, wherein the filler comprises micro-sized particles having an average particle size of from: about 1 μm to about 38 μm; about 38 μm to about 300 μm; or, less than about 1 μm.

39. (canceled)

40. (canceled)

41. (canceled)

42. (canceled)

43. The method of claim 14, wherein the filler is added and compounded at about 5-PHR to about 30 PHR and wherein the carbon black is added and compounded at about 30 PHR to about 0.1 PHR.

44. A product made using the method of claim 32.

45. (canceled)

46. The product of claim 44, wherein the product is a gasket.

47. (canceled)

48. (canceled)

49. (canceled)

50. (canceled)

51. (canceled)

52. (canceled)

53. (canceled)

54. The rubber composite of claim 1, wherein the synthetic solid rubber compound comprises a rubber component selected from the group consisting of: styrene butadiene (SBR); polybutadiene; ethylene propylene diene monomer (EPDM); hydrogenated nitrile butadiene (HNBR); and isobutylene isoprene butyl.

55. (canceled)

56. (canceled)
